(19) United States
(12) Patent Application Publication
(10) Pub. No.: US 2026/0312876 A1
(43) Pub. Date: Oct. 8, 2026

(54) PREDICTION APPARATUS, COMMUNICATION CONTROL APPARATUS AND PREDICTION METHOD

(71) Applicant: NTT, Inc., Tokyo (JP)

(72) Inventors: Yuka OKAMOTO, Musashino-shi (JP); Hirotaka UJIKAWA, Musashino-shi (JP); Yoshihito SAKAI, Musashino-shi (JP); Tatsuya SHIMADA, Musashino-shi (JP)

(73) Assignee: NTT, Inc., Tokyo (JP)

(21) Appl. No.: 19/482,998

(22) PCT Filed: May 17, 2023
(86) PCT No.: PCT/JP2023/018394

§ 371 Date: Nov. 10, 2025

(51) Int. Cl. H04L 41/147

(52) U.S. Cl. CPC H04L 41/147

(57) ABSTRACT

A prediction apparatus includes a flow classification unit configured to classify communication traffic input during a predetermined period into a plurality of flows on a basis of a characteristic of the communication traffic, a first prediction unit configured to predict a future traffic amount of the flow using a first prediction method on a basis of a current traffic amount of the flow, a second prediction unit configured to predict a future traffic amount of the flow using a second prediction method having a smaller calculation amount than the first prediction method on the basis of the current traffic amount of the flow, a prediction method determination unit configured to determine a prediction method to be used for each of the flows on the basis of the characteristic of the communication traffic, and a total traffic calculation unit configured to calculate a total value of the traffic amount for each of the flows predicted by the first prediction unit and the traffic amount for each of the flows predicted by the second prediction unit.

### TECHNICAL FIELD

The present invention relates to a prediction apparatus, a communication control apparatus and a prediction method.

### BACKGROUND ART

In a case where communication is simultaneously performed by a plurality of communication apparatuses, such as a case where a plurality of upper apparatuses and a plurality of lower apparatuses communicate with each other, congestion may occur and a communication delay may occur. The congestion may be resolved by switching a communication path (hereinafter referred to as “path switching”) by a switching apparatus installed in the communication path and changing a connection relationship between the upper apparatus and the lower apparatus. If communication traffic (hereinafter simply referred to as “traffic”) concentrated on a specific communication apparatus (for example, an upper apparatus) can be distributed to a plurality of communication apparatuses by the path switching, the congestion can be eliminated, and the communication delay can be reduced.

Conventionally, in a communication system including a switching apparatus capable of changing a connection relationship between an upper apparatus and a lower apparatus, there is a technology of collecting information (hereinafter simply referred to as “traffic amount”) indicating an amount of traffic measured by the upper apparatus or the lower apparatus, determining the presence or absence of occurrence of congestion at an offload destination on the basis of the collected traffic amount, and performing path switching.

### CITATION LIST

### Patent Literature

Patent Literature 1: JP 2014-060610 A
Patent Literature 2: JP 10-285276 A

### Non Patent Literature

Non Patent Literature 1: Y. Okamoto, et al., “Short-term traffic prediction based on mobile control information for proactive optical switching to lower congestion delay,” International Conference on Emerging Technologies for Communications (ICETC), 2022

### SUMMARY OF INVENTION

### Technical Problem

A conventional communication system calculates a congestion value indicating a degree of congestion on the basis of a traffic amount of each communication path, and performs path switching in a case where the congestion value of any communication path exceeds a threshold. However, in general, it takes a certain time to perform the path switching. Therefore, in the conventional communication system, the congestion is kept generated from the occurrence of the congestion to completion of the path switching. Therefore, the time required for the path switching is also one of factors of the communication delay. For example, in the techniques described in Patent Literatures 1 and 2, since it takes time from collection of an actual traffic amount to execution of path switching, it is difficult to determine the presence or absence of occurrence of congestion in real time (for example, in several milliseconds) and execute the path switching within a predetermined period (for example, within several tens of milliseconds).

In contrast, a method of avoiding occurrence of congestion by predicting a future traffic amount and performing path switching in advance on the basis of a prediction value instead of performing the path switching on the basis of an actual measurement value of the traffic amount is conceivable. However, in an actual communication environment in which a plurality of traffic flows having various traffic characteristics (hereinafter the traffic flows will be simply referred to as “flows”) is mixed as in recent communication performed with various types of quality of service (Qos) among a large number of communication apparatuses, there is a problem that prediction accuracy is lowered if future traffic amounts of all the flows are collectively predicted.

On the other hand, in a case where the future traffic amount is predicted for each flow, a calculation load related to the prediction increases in proportion to the number of flows. As a result, there is a problem that a calculation time required for the prediction becomes long and the path switching cannot be completed before congestion actually occurs. As described above, the conventional techniques have a problem that even if execution determination of the path switching is performed on the basis of the prediction value of the traffic amount, the occurrence of congestion cannot be prevented and the communication delay may occur.

In view of the above circumstances, an object of the present invention is to provide a prediction apparatus, a communication control apparatus and a prediction method capable of reducing a communication delay while satisfying communication quality even in a case where a plurality of flows is mixed.

### Solution to Problem

One aspect of the present invention is a prediction apparatus including: a flow classification unit configured to classify communication traffic input during a predetermined period into a plurality of flows on a basis of a characteristic of the communication traffic; a first prediction unit configured to predict a future traffic amount of the flow using a first prediction method on a basis of a current traffic amount of the flow; a second prediction unit configured to predict a future traffic amount of the flow using a second prediction method having a smaller calculation amount than the first prediction method on the basis of the current traffic amount of the flow; a prediction method determination unit configured to determine a prediction method to be used for each of the flows on the basis of the characteristic of the communication traffic; and a total traffic calculation unit configured to calculate a total value of the traffic amount for each of the flows predicted by the first prediction unit and the traffic amount for each of the flows predicted by the second prediction unit.

Further, one aspect of the present invention is a communication control apparatus including: a flow classification unit configured to classify communication traffic input during a predetermined period into a plurality of flows on a basis of a characteristic of the communication traffic; a first prediction unit configured to predict a future traffic amount of the flow using a first prediction method on a basis of a current traffic amount of the flow; a second prediction unit configured to predict a future traffic amount of the flow using a second prediction method having a smaller calculation amount than the first prediction method on the basis of the current traffic amount of the flow; a prediction method determination unit configured to determine a prediction method to be used for each of the flows on the basis of the characteristic of the communication traffic; a total traffic calculation unit configured to calculate a total value of the traffic amount for each of the flows predicted by the first prediction unit and the traffic amount for each of the flows predicted by the second prediction unit; a switching determination unit configured to predict presence or absence of occurrence of congestion in a future on a basis of the total value, and determine necessity of switching of a communication path on a basis of a prediction result; and a switching instruction unit configured to issue a switching instruction to a switching apparatus that executes the switching of a communication path in a case where the switching determination unit determines that the switching of a communication path is necessary.

Further, one aspect of the present invention is a prediction method executed by a computer, the prediction method including: a flow classification step of classifying communication traffic input during a predetermined period into a plurality of flows on a basis of a characteristic of the communication traffic; a first prediction step of predicting a future traffic amount of the flow using a first prediction method on a basis of a current traffic amount of the flow; a second prediction step of predicting a future traffic amount of the flow using a second prediction method having a smaller calculation amount than the first prediction method on the basis of the current traffic amount of the flow; a prediction method determination step of determining a prediction method to be used for each of the flows on the basis of the characteristic of the communication traffic; and a total traffic calculation step of calculating a total value of the traffic amount for each of the flows predicted in the first prediction step and the traffic amount for each of the flows predicted in the second prediction step.

### Advantageous Effects of Invention

According to the present invention, it is possible to suppress occurrence of congestion and reduce a communication delay while satisfying communication quality even in a case where a plurality of flows is mixed.

### BRIEF DESCRIPTION OF DRAWINGS

FIG. 1 is a diagram illustrating a configuration of a communication system 1 that is an example of a conventional communication system.

FIG. 2 is a diagram illustrating a configuration of a mobile communication system 10 that is an example of a conventional communication system.

FIG. 3 is a block diagram illustrating a configuration of a switching instruction apparatus 17 of the mobile communication system 10 that is an example of a conventional communication system.

FIG. 4 is a diagram illustrating a flow of processing in the switching instruction apparatus 17 of the mobile communication system 10 that is an example of a conventional communication system.

FIG. 5 is a flowchart illustrating distributed station traffic amount prediction processing in a prediction unit 171.

FIG. 6 is a flowchart illustrating traffic amount prediction model creation processing of the prediction unit 171.

FIG. 7 is a flowchart illustrating future traffic amount prediction processing of the prediction unit 171.

FIG. 8 is a flowchart illustrating upper link traffic amount prediction processing in the prediction unit 171.

FIG. 9 is a flowchart illustrating switching threshold calculation processing in a switching threshold determination unit 172.

FIG. 10 is a table illustrating an example of a lookup table.

FIG. 11 is a flowchart illustrating switching determination processing in a switching determination unit 175.

FIG. 12 is a flowchart illustrating the switching determination processing in the switching determination unit 175.

FIG. 13 is a block diagram illustrating a functional configuration of a prediction unit 171a of the communication system in a first embodiment of the present invention.

FIG. 14 is a schematic diagram for describing definition of a flow as a precondition in the first embodiment of the present invention.

FIG. 15 is a table illustrating an example of a configuration of a flow information table in the first embodiment of the present invention.

FIG. 16 is a block diagram illustrating a functional configuration of a prediction execution unit 730 of the communication system in the first embodiment of the present invention.

FIG. 17 is a block diagram illustrating a functional configuration of a prediction unit 171b of the communication system in a second embodiment of the present invention.

FIG. 18 is a flowchart illustrating an operation of a prediction execution unit 730b of the communication system in the second embodiment of the present invention.

FIG. 19 is a block diagram illustrating a functional configuration of a prediction unit 171c of the communication system in a third embodiment of the present invention.

FIG. 20 is a flowchart illustrating an operation of a prediction execution unit 730c of the communication system in the third embodiment of the present invention.

FIG. 21 is a block diagram illustrating a functional configuration of a prediction unit 171d of a communication system in a fourth embodiment of the present invention.

FIG. 22 is a flowchart illustrating an operation of a prediction execution unit 730d of the communication system in the fourth embodiment of the present invention.

FIG. 23 is a block diagram illustrating a functional configuration of a prediction unit 171e of the communication system in a fifth embodiment of the present invention.

FIG. 24 is a flowchart illustrating an operation of a prediction execution unit 730e of the communication system in the fifth embodiment of the present invention.

FIG. 25 is a block diagram illustrating a functional configuration of a prediction unit 171f of a communication system in a sixth embodiment of the present invention.

FIG. 26 is a flowchart illustrating an operation of a prediction execution unit 730f of the communication system in the sixth embodiment of the present invention.

FIG. 27 is a block diagram illustrating a functional configuration of a prediction unit 171g of a communication system in a seventh embodiment of the present invention.

FIG. 28 is a block diagram illustrating functional configurations of a switching threshold determination unit 172g and a switching determination unit 175g of the switching instruction apparatus 17g in the seventh embodiment of the present invention.

FIG. 29 is a flowchart illustrating an operation of a switching flow calculation unit 177 of the switching determination unit 175g in the seventh embodiment of the present invention.

FIG. 30 is a diagram for describing prediction method determination by a prediction method determination unit in each embodiment of the present invention.

### DESCRIPTION OF EMBODIMENTS

Hereinafter, a prediction apparatus, a communication control apparatus and a prediction method according to embodiments of the present invention will be described in detail with reference to the drawings. Note that, in the embodiments, components having the same function are denoted by the same reference numerals, and repeated description of the function may be omitted.

Hereinafter, to make description of configurations of communication systems in the embodiments of the present invention easier to understand, an example of a configuration of a conventional communication system as a comparison target will be described first.

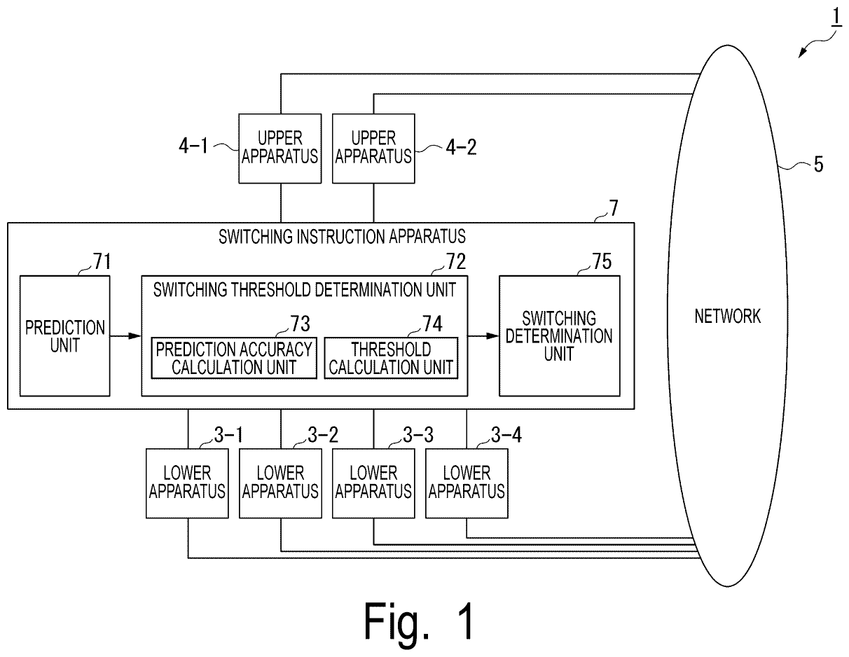

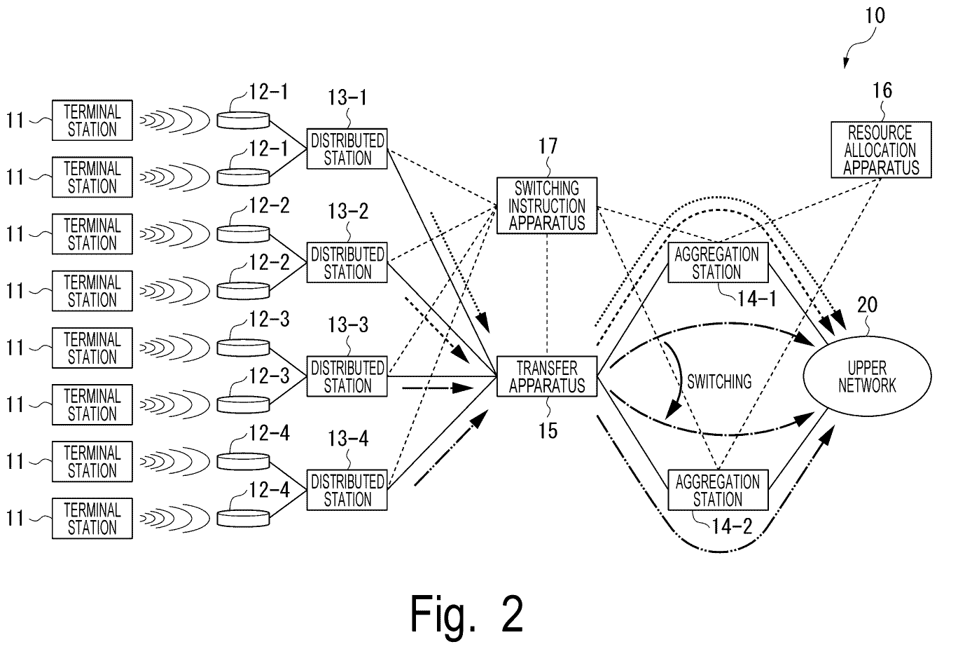

FIG. 1 is a diagram illustrating a configuration of a communication system 1 that is an example of a conventional communication system. The communication system 1 includes a plurality of lower apparatuses 3, a plurality of upper apparatuses 4, and a switching instruction apparatus 7. The lower-level apparatuses 3 and the higher-level apparatuses 4 are connected via a network 5. The network 5 includes one or more transfer apparatuses (that are not illustrated and correspond to a transfer apparatus 15 illustrated in FIG. 2 to be described below). The transfer apparatus also functions as a switching apparatus capable of changing a connection relationship between the lower apparatus 3 and the upper apparatus 4.

In FIG. 1, the four lower apparatuses 3 are respectively referred to as lower apparatuses 3-1 to 3-4, and the two upper apparatuses 4 are respectively referred to as upper apparatuses 4-1 and 4-2. Hereinafter, a direction from the lower apparatus 3 to the upper apparatus 4 is described as “uplink”, and a direction from the upper apparatus 4 to the lower apparatus 3 is described as “downlink”.

The lower apparatus 3 transmits an uplink signal to the upper apparatus 4 at a connection destination. The network 5 transfers the uplink signal to the upper apparatus 4 according to a communication path between the lower apparatus 3 and the upper apparatus 4. Further, the upper apparatus 4 transmits a downlink signal to the lower apparatus 3 at the connection destination. The network 5 transfers the downlink signal to the lower apparatus 3 according to the communication path between the lower apparatus 3 and the upper apparatus 4. The switching instruction apparatus 7 instructs each apparatus such as the transfer apparatus to switch the communication path.

The switching instruction apparatus 7 predicts traffic amounts of some or all of communication links (hereinafter simply referred to as “links” or “flows”) in the communication path between the lower apparatus 3 and the upper apparatus 4 in advance, using information of traffic amounts, traffic allocation amounts, and the like (hereinafter collectively referred to as “traffic amounts”) acquired from the lower apparatus 3 and the upper apparatus 4. The switching instruction apparatus 7 determines a switching threshold for each link on the basis of prediction accuracy of the traffic amount and transmission capability of the link.

For example, a link rate can be used as an index representing the transmission capability of the link. The link rate is a maximum communication speed of the link. The switching threshold is a threshold used to determine whether or not to predict occurrence of congestion that requires switching of the communication path (path switching). For example, even at the same link rate, the switching instruction apparatus 7 determines the switching threshold to be lower as the prediction accuracy of the traffic amount is lower.

The switching instruction apparatus 7 determines, for each link, whether congestion occurs using the predicted traffic amount and the switching threshold. In a case of predicting that congestion occurs in any link, the switching instruction apparatus 7 determines to perform the path switching for load distribution. The switching instruction apparatus 7 gives an instruction for switching of the communication path (path switching) so that at least some of the traffic transmitted by the link predicted to have congestion is transmitted by a link predicted not to have congestion. As a result, it is possible to perform optimum switching of the communication path according to the prediction accuracy. In addition, it is possible to reduce a congestion delay of the link, and further increase high utilization efficiency of a band.

As illustrated in FIG. 1, the switching instruction apparatus 7 includes a prediction unit 71, a switching threshold determination unit 72, and a switching determination unit 75. The prediction unit 71 acquires prediction information used to predict the traffic amount of each link from each apparatus. The prediction information is, for example, information of the traffic amount observed by the apparatus, the traffic allocation amount to the apparatus, the number of connected terminals of the apparatus, communication quality, and the like. The prediction unit 71 predicts a future traffic amount for each link, using the prediction information. Note that any existing technique is used to predict the future traffic amount.

The switching threshold determination unit 72 includes a prediction accuracy calculation unit 73 and a threshold calculation unit 74. The prediction accuracy calculation unit 73 calculates the prediction accuracy for each link on the basis of a prediction result of the future traffic amount in the past and the actual traffic amount. The threshold calculation unit 74 determines the switching threshold for each link so that the lower the prediction accuracy, the lower the ratio to the transmission capability of the link (for example, the link rate).

The switching determination unit 75 determines in advance the presence or absence of occurrence of congestion for each link using a value of the predicted future traffic amount and the switching threshold. In a case where the occurrence of congestion is predicted, the switching determination unit 75 determines to perform the path switching for load distribution. For example, the switching determination unit 75 determines to execute the path switching from a link in which occurrence of congestion is predicted to a link with a lower link use rate. The switching determination unit 75 instructs each apparatus to execute processing for the path switching.

Hereinafter, an example in which the communication system 1 is applied to a mobile communication system will be described.

FIG. 2 is a diagram illustrating a configuration of a mobile communication system 10 that is an example of a conventional communication system. The mobile communication system 10 is an example of the communication system 1. The mobile communication system 10 is, for example, a fifth generation mobile communication system (5G). The mobile communication system 10 includes a plurality of terminal stations 11, a plurality of antenna stations 12, a plurality of distributed stations 13, a plurality of aggregation stations 14, a transfer apparatus 15, a switching instruction apparatus 17, and a resource allocation apparatus 16.

The terminal station 11, the antenna station 12, the distributed station 13, and the aggregation station 14 are user equipment (UE), a radio unit (RU), a distributed unit (DU), and a central unit (CU) of the fifth generation mobile communication system, respectively. The distributed station 13 is an example of the lower apparatus 3, and the aggregation station 14 is an example of the upper apparatus 4. Note that the combination of a apparatus corresponding to the lower apparatus 3 and a apparatus corresponding to the upper apparatus 4 is not limited to the combination of the distributed station 13 and the aggregation station 14, and may be any combination. The transfer apparatus 15 is an example of a transfer apparatus constituting the network 5.

The transfer apparatus 15 also functions as a switching apparatus capable of changing a connection relationship between the distributed station 13 and the aggregation station 14. Note that the transfer function and the switching function of the transfer apparatus 15 may be implemented by different apparatuses. Note that the apparatuses such as the switching instruction apparatus 17, the transfer apparatus 15, and the resource allocation apparatus 16 are not necessarily separate apparatuses, and may be configured as an integrated apparatus.

The mobile communication system 10 is connected to an upper network 20. Here, M (M is an integer of 1 or more) distributed stations 13 are referred to as distributed stations 13-1 to 13-M, respectively. Furthermore, Km (Km is an integer of 1 or more) antenna stations 12 subordinate to the distributed station 13-m (m is an integer of 1 or more and M or less) are referred to as antenna stations 12-m. Further, N (N is an integer of 2 or more) aggregation stations 14 are referred to as aggregation stations 14-1 to 14-N, respectively. Therefore, the mobile communication system 10 illustrated in FIG. 2 is an example of a mobile communication system with M=4, K1=2, K2=2, K3=2, K4=2, and N=2.

The terminal station 11 transmits and receives radio signals to and from the antenna station 12 using a radio resource allocated from the distributed station 13. The allocated radio resource includes information indicating start timing and end timing of a time section in which each of transmission and reception of radio signals is permitted. The start timing and the end timing are represented by slots, for example. A slot is a scheduling unit of data transmission and reception in a radio frame. The allocated radio resource may further include information indicating a coding rate and a modulation scheme.

The antenna station 12 receives uplink data from the terminal station 11 by a radio signal. The antenna station 12-m sets the received uplink data as an uplink signal and transmits the uplink signal to the distributed station 13-m by a wired interface. Further, the antenna station 12-m receives a downlink signal from the distributed station 13-m via the wired interface. The antenna station 12 transmits downlink data addressed to the terminal station 11 set as the received downlink signal to the terminal station 11 by a radio signal.

The distributed station 13-m receives the uplink signal from each of the Km antenna stations 12-m. The uplink signal received by the distributed station 13-m includes the uplink data received by the antenna station 12-m from the subordinate terminal station 11. The distributed station 13 generates an uplink signal obtained by aggregating the uplink data, and transmits the generated uplink signal to the aggregation station 14 as the connection destination of the own unit. Further, the distributed station 13 receives the downlink signal in which the downlink data addressed to the subordinate terminal station 11 is set from the aggregation station 14 as the connection destination of the own station. The distributed station 13-m converts the received downlink signal into a downlink signal corresponding to the radio signal to be transmitted from each antenna station 12-m. The distributed station 13-m transmits the converted downlink signal to the antenna station 12-m corresponding to the downlink signal.

The aggregation station 14 aggregates the uplink signals received from the subordinate distributed stations 13 and transfers the uplink signals to the upper network 20. In addition, the aggregation station 14 receives the downlink signal in which the downlink data addressed to the terminal station 11 is set from the upper network 20, and transfers the received downlink signal to the distributed station 13 connected to the addressed terminal station 11.

The transfer apparatus 15 is connected to the distributed station 13, the aggregation station 14, and the switching instruction apparatus 17. The transfer apparatus 15 is an example of a switching apparatus that executes switching (switching) of the communication path. The transfer apparatus 15 transfers a signal according to the communication path between the distributed station 13 and the aggregation station 14. That is, the transfer apparatus 15 transfers the uplink signal received from the distributed station 13 to the addressed aggregation station 14 according to the communication path. In addition, the transfer apparatus 15 transfers the downlink signal received from the aggregation station 14 to the addressed distributed station 13 according to the communication path. The transfer of the signal performed according to the communication path is performed under an instruction from the switching instruction apparatus 17. The resource allocation apparatus 16 manages resources of the aggregation station 14.

The switching instruction apparatus 17 is connected to the distributed station 13, the aggregation station 14, and the transfer apparatus 15. Further, the switching instruction apparatus 17 may be connected to the resource allocation apparatus 16. The switching instruction apparatus 17 instructs the transfer apparatus 15 (switching apparatus) to switch the communication path between the distributed station 13 and the aggregation station 14. In the mobile communication system 10, the communication path between the distributed station 13 and the aggregation station 14 is determined on the basis of the connection relationship between the distributed station 13 and the aggregation station 14. Therefore, the mobile communication system 10 performs the path switching between the distributed station 13 and the aggregation station 14 by controlling the transfer apparatus 15 (switching apparatus) so as to change the aggregation station 14 as the connection destination of the distributed station 13.

Furthermore, here, as an example, it is assumed that the switching instruction apparatus 17 of the mobile communication system 10 determines the presence or absence of occurrence of congestion on the aggregation station 14 side corresponding to the upper apparatus 4 on the basis of uplink traffic. Therefore, the traffic in the following description means uplink signal traffic unless otherwise specified.

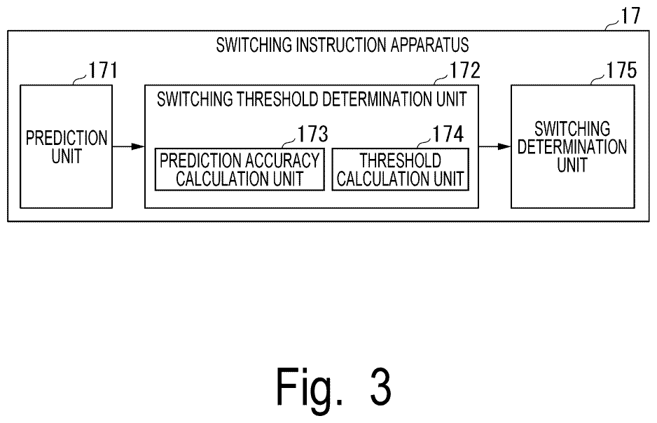

FIG. 3 is a block diagram illustrating a configuration of the switching instruction apparatus 17 of the mobile communication system 10 that is an example of a conventional communication system. The switching instruction apparatus 17 includes a prediction unit 171, a switching threshold determination unit 172, and a switching determination unit 175.

The prediction unit 171 receives the radio information as the prediction information from the distributed station 13. The radio information indicates information indicating the radio resource allocated to the subordinate terminal station 11 of the distributed station 13. The radio information is, for example, downlink control information (DCI). The prediction unit 171 calculates the future traffic amount of each distributed station 13 using the radio information from the distributed station 13.

Further, the prediction unit 171 calculates a future traffic amount of each upper link on the basis of the connection relationship between the distributed station 13 and the aggregation station 14 and the future traffic amount of each distributed station 13. The upper link is a link between the aggregation station 14 and the transfer apparatus 15. An uplink traffic amount of the upper link between the aggregation station 14-n (n is an integer of 1 or more and N or less) and the transfer apparatus 15 corresponds to a total value of the traffic amounts of the uplink signals received by the aggregation station 14-n from the respective subordinate distributed stations 13. The prediction unit 171 outputs the future traffic amount of the upper link to each of the switching threshold determination unit 172 and the switching determination unit 175.

The switching threshold determination unit 172 includes a prediction accuracy calculation unit 173 and a threshold calculation unit 174. The prediction accuracy calculation unit 173 receives information indicating the actual traffic amount from the distributed station 13. The prediction accuracy calculation unit 173 calculates the actual traffic amount that has flown to each upper link on the basis of the actual traffic amount and the connection relationship between the distributed station 13 and the aggregation station 14. The prediction accuracy calculation unit 173 calculates the prediction accuracy for each upper link on the basis of the future traffic amount predicted in the past by the prediction unit 171 and the actual traffic amount. The threshold calculation unit 174 calculates the switching threshold for each upper link on the basis of the link rate and the prediction accuracy. The threshold calculation unit 174 outputs the calculated switching threshold of each upper link to the switching determination unit 175.

The switching determination unit 175 calculates a predicted link use rate for each upper link on the basis of the value of the future traffic amount received from the prediction unit 171 and the switching threshold received from the threshold calculation unit 174. In a case where there is an upper link determined to have congestion due to a high predicted link use rate, the switching determination unit 175 determines to perform the path switching by changing the aggregation station 14 as the connection destination of the distributed station 13. In a case of determining to perform the path switching, the switching determination unit 175 instructs each apparatus (the distributed station 13, the aggregation station 14, and the transfer apparatus 15) to perform the path switching.

Specifically, the switching determination unit 175 instructs the aggregation station 14 as the connection destination before the path switching (hereinafter referred to as a “switching source”) to release the connection with the distributed station 13, and instructs the aggregation station 14 as the connection destination after the path switching (hereinafter, “switching destination”) to be connect with the distributed station 13. Further, the switching instruction apparatus 17 instructs the transfer apparatus 15 (switching apparatus) to perform the path switching so that signal transfer is performed through the communication path after the path switching.

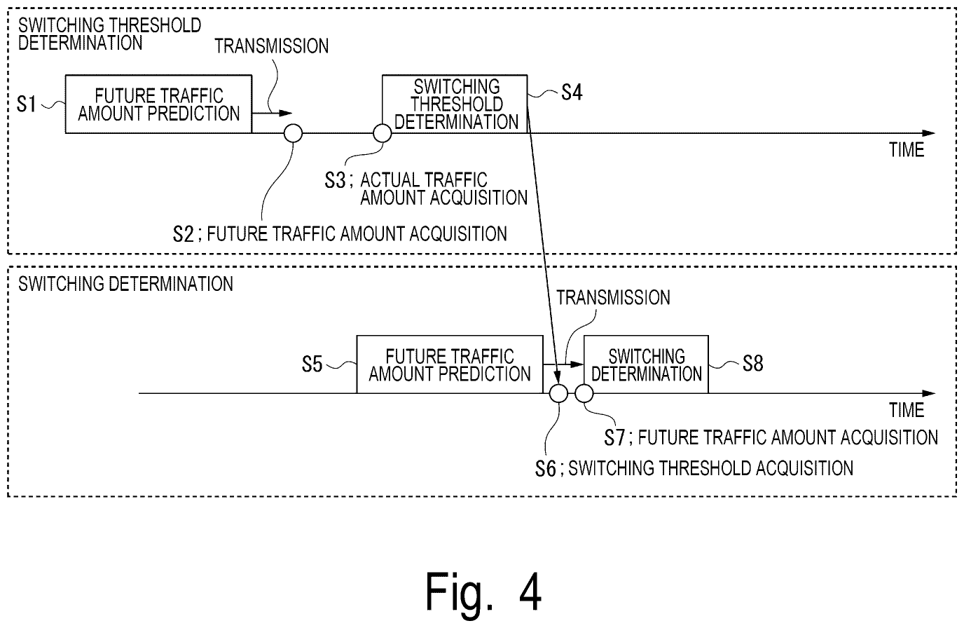

FIG. 4 is a diagram illustrating a flow of processing in the switching instruction apparatus 17 of the mobile communication system 10 that is an example of a conventional communication system. For example, the prediction unit 171 predicts the future traffic amount of the upper link in a period D(a) (step S1). The prediction accuracy calculation unit 173 acquires information indicating the future traffic amount predicted in step S1 from the prediction unit 171 and stores the information until acquiring the information indicating the actual traffic amount in the period D(a) (step S2).

The prediction accuracy calculation unit 173 receives the information indicating the actual traffic amount in the period D(a) of the upper link (step S3). The prediction accuracy calculation unit 173 calculates the prediction accuracy on the basis of the stored future traffic amount in the period D(a) and the received actual traffic amount in the period D(a). The threshold calculation unit 174 determines the switching threshold on the basis of the link rate and the prediction accuracy of the upper link (step S4). The threshold calculation unit 174 outputs the determined switching threshold to the switching determination unit 175.

Meanwhile, the prediction unit 171 calculates the future traffic amount of the upper link in a period D(b) that is a period after the period D(a) (step S5). The switching determination unit 175 acquires the switching threshold output in step S4 from the threshold calculation unit 174 (step S6). Further, the switching determination unit 175 acquires information indicating the future traffic amount in the period D(b) calculated in step S5 from the prediction unit 171 (step S7). The switching determination unit 175 determines necessity of the path switching on the basis of the acquired switching threshold and a value of the acquired future traffic amount in the period D(b) (step S8).

As described above, the future traffic amount acquired by the switching threshold determination unit 172 is a traffic amount at time earlier than the future traffic amount acquired by the switching determination unit 175.

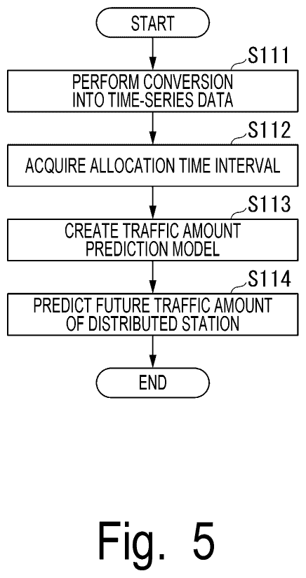

Next, detailed processing of the switching instruction apparatus 17 will be described. First, processing of predicting the future traffic amount of each upper link in the prediction unit 171 will be described. The prediction unit 171 performs the processing of steps S1 and S5 of FIG. 4 by processing of FIGS. 5 to 8 below.

FIG. 5 is a flowchart illustrating distributed station traffic amount prediction processing in the prediction unit 171. At time t(i−1), the distributed station 13 notifies the terminal station 11 of DCI(i) of a next transmission period, and further notifies the switching instruction apparatus 17 of DCI information in which the DCI(i) is set (i is an integer). DCI(i) is DCI indicating the radio resource allocated to the terminal station 11 in slot SL(i) from time t(i) to time t(i+1), and the coding rate and the modulation scheme used by terminal station 11.

Specifically, the DCI includes scheduling information necessary for the terminal station 11 to transmit the uplink data, a modulation and coding scheme (MCS), and the like. The scheduling information is represented by a resource block. The resource block is represented by a channel, and transmission start timing and transmission end timing using the channel. The MCS represents data modulation and a channel coding rate. A transport block size (TBS) is determined on the basis of the size of the resource block and the MCS. The traffic amount can be predicted with the TBS.

The switching instruction apparatus 17 receives DCI information in which the DCI(i) is set from each distributed station 13 at time t(i−1). The prediction unit 171 calculates a predicted traffic amount DU(i) of the distributed station 13 in the period D(i) corresponding to the slot SL(i) on the basis of the information included in the DCI(i) (step S111). Further, the prediction unit 171 calculates an allocation time interval T(i) from a difference between time t(i) and time t(i+1) (step S112). The allocation time interval T(i) corresponds to a time length of the slot SL(i), that is, a time length of the period D(i) from time t(i) to time t(i+1). The prediction unit 171 may receive the allocation time interval T(i) from the distributed station 13. The prediction unit 171 stores the predicted traffic amount DU(i) of each distributed station 13, the allocation time interval T(i), and the period D(i) in association with one another.

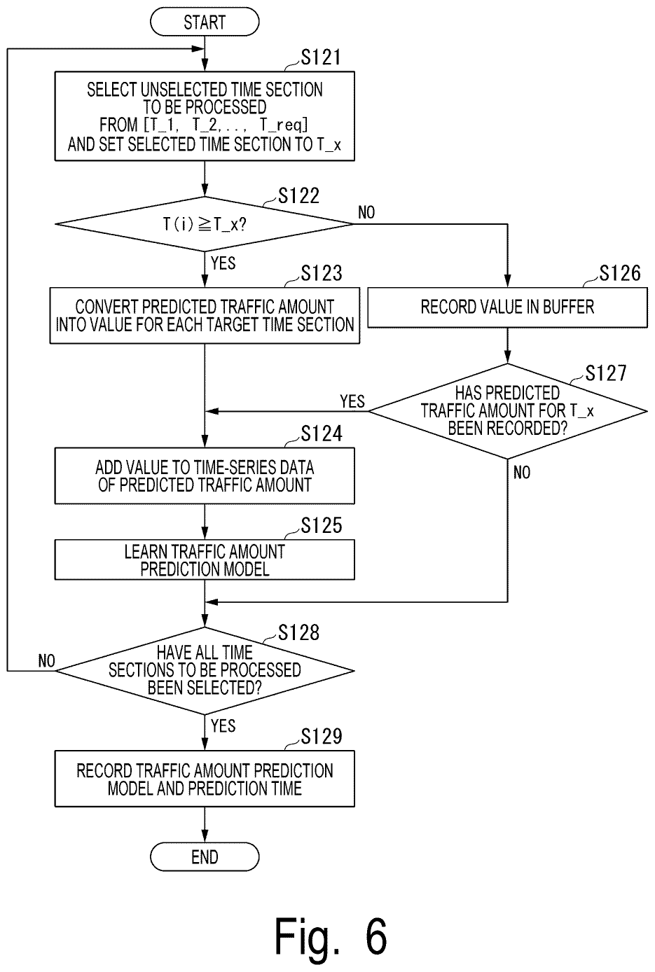

The prediction unit 171 creates a traffic amount prediction model (step S113). The traffic amount prediction model is a model that uses the traffic amounts of time-series q (for example, q=100) slots as input data and predicts the traffic amount of a slot next to the input data. Details of the creation of the traffic amount prediction model will be described below with reference to FIG. 6.

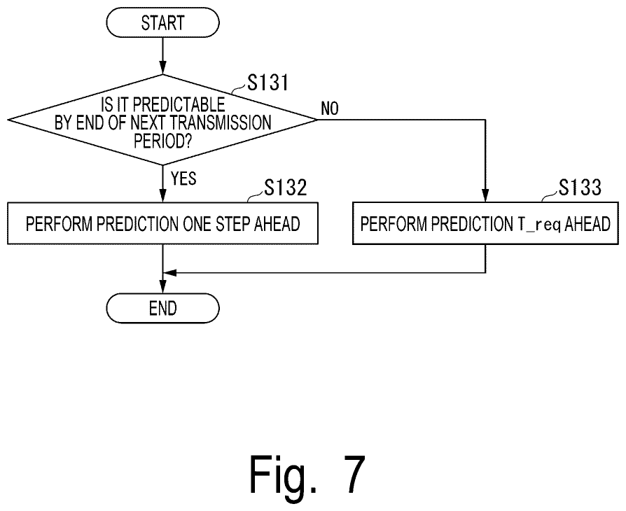

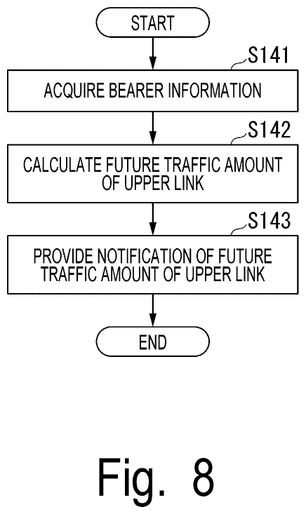

The prediction unit 171 predicts the future traffic amount DU(i+1) of each distributed station 13 in the period D(i+1) from time t(i+1) to time t(i+2) using the traffic amount prediction model created in step S113 (step S114). Details of the prediction processing will be described below with reference to FIG. 7. After the processing of step S114, the prediction unit 171 performs processing of FIG. 8 to be described below and calculates the traffic amount for each upper link.

FIG. 6 is a flowchart illustrating traffic amount prediction model creation processing of the prediction unit 171. FIG. 6 illustrates detailed processing in step S113 of FIG. 5.

The prediction unit 171 stores K time sections T_1, T_2, . . . , T_k−1, and T_req to be processed in advance. The time sections T_1 to T_k−1 are the time lengths of the slots that can be used when the resource blocks are allocated to the terminal station 11. For example, T_1 to T_k−1 are 125 [us], 250 [us], 500 [us], and 1 [ms]. The allocation time interval T(i) has the same value as any one of the time sections T_1 to T_k−1. The time section T_req is a value required by an application or the like. The time section T_req is a value larger than T_1 to T_k−1. The prediction unit 171 selects one of the unselected time sections T_1 to T_req and sets the selected time section to T_x (step S121).

The prediction unit 171 determines whether or not the allocation time interval T(i) is equal to or greater than to the time section T_x (step S122). In a case of determining that the allocation time interval T(i) is equal to or greater than the time section T_x (step S122: YES), the prediction unit 171 converts the predicted traffic amount DU(i) of the distributed station 13 into the predicted traffic amount for each time section T_x (step S123).

That is, the prediction unit 171 calculates that the predicted traffic amount DU_T_x of the predicted traffic amount DU(i)×(the time section T_x/the allocation time interval T(i)) is generated for each time section T_x between time t(i) and time t (i+1). For example, it is assumed that the allocation time interval T(i) is 250 μs and the time section T_x is 125 μs. The prediction unit 171 predicts that the traffic amount DU 125 μs=DU(i)/2 is to be generated between time t(i) and time t(i)+125 us and between time t(i)+125 μs and time t(i+1).

The prediction unit 171 additionally stores the predicted traffic amount calculated in step S123 to the time-series predicted traffic amounts calculated in the past for the time section T_x for each distributed station 13 (step S124). The prediction unit 171 learns the traffic amount prediction model of the time section T_x using the stored time-series predicted traffic amounts of the distributed station 13 in the time section T_x (step S125).

For example, the time-series predicted traffic amounts of the distributed station 13 in the time section T_x are DU_T_x(P), DU_T_x(P−1), DU_T_x(P−2), . . . , DU_T_x (1) in reverse chronological order (P is an integer of 2 or more). The prediction unit 171 generates, for each distributed station 13, learning data having DU_T_x (p) as correct output data and DU_T_x (p−1) to DU_T_x (p−q) as input data while sequentially subtracting the value of p from P by 1 (q is an integer of 1 or more, for example, q=100). The prediction unit 171 learns the traffic amount prediction model representing a correspondence between the input data and output data using the generated learning data.

On the other hand, in step S122, in a case of determining that the allocation time interval T(i) is smaller than the time section T_x (step S122: NO), the prediction unit 171 performs the processing of step S126. The prediction unit 171 records the predicted traffic amount DU(i) of the distributed station 13-m in a buffer corresponding to the distributed station 13-m and the time section T_x in the prediction unit 171 (step S126). The prediction unit 171 determines whether or not the predicted traffic amount for the time section T_x has been recorded in the buffer corresponding to each distributed station 13 and the time section T_x (step S127).

For example, it is assumed that the allocation time interval T(i) is 250 [us] and the time section T_x is 500 [us]. The prediction unit 171 determines whether the predicted traffic amount corresponding to T_x/T(i)=2 has been recorded in the buffer corresponding to 500 [us]. In a case of determining that the predicted traffic amount for the time section T_x is not recorded in the buffer corresponding to the time section T_x (step S127: NO), the prediction unit 171 performs the processing from step S128.

In a case of determining that the predicted traffic amount for the time section T_x is recorded in the buffer corresponding to the time section T_x for each distributed station 13 (step S127: YES), the prediction unit 171 performs the processing from step S124. That is, the prediction unit 171 reads and sums the predicted traffic amount DU(i−T_x/T(i)+1) to the predicted traffic amount DU(i) from the buffer corresponding to the time section T_x for each distributed station 13 to obtain DU_T_x(P).

For example, it is assumed that the allocation time interval T(i) is 250 [us] and the time section T_x is 500 [us]. The prediction unit 171 sums the predicted traffic amount DU(i−1) and the predicted traffic amount DU(i) to calculate DU 500 [us] (P).

The prediction unit 171 stores the time-series predicted traffic amounts DU_T_x (1) to DU_T_x(P−1) of each distributed station 13 calculated in the past for the time section T_x. The prediction unit 171 additionally stores the newly calculated predicted traffic amount DU_T_x(P) to the predicted traffic amounts DU_T_x (1) to DU_T_x(P−1) for each distributed station 13 (step S124). The prediction unit 171 performs the processing of step S125 and learns the traffic amount prediction model using the time-series predicted traffic amount in the time section T_x.

After the processing of step S125 or in a case of determining NO in step S127, the prediction unit 171 determines whether or not to have selected all the K time sections T_1 to T_req to be processed (step S128). In a case where there is an unselected time section (step S128: NO), the prediction unit 171 returns to step S121 and sets a newly selected time section to T_X.

Then, in a case of determining to have selected all the K time sections to be processed (step S128: YES), the prediction unit 171 stores the traffic amount prediction model corresponding to each of the K time sections T_1 to T_req and a prediction time that is a time from when the input data is input to the traffic amount prediction model to when the output data is output (step S129).

FIG. 7 is a flowchart illustrating future traffic amount prediction processing of the prediction unit 171. FIG. 7 illustrates detailed processing in step S114 of FIG. 5. The prediction unit 171 determines whether or not the future traffic amount is predictable by time t(i+1) when the next period D(i) ends (step S131). Specifically, the prediction unit 171 determines whether or not a sum of the allocation time interval T(i) and a switching time Tc is longer than the prediction time of the traffic amount prediction model of the allocation time interval T(i).

In a case where the allocation time interval T(i)+the switching time Tc is longer than the prediction time (T(i)+Tc>the prediction time), the prediction unit 171 determines that the prediction of the future traffic amount is possible by the end of the next period D(i) (step S131: YES). The prediction unit 171 inputs p time-series predicted traffic amounts DU (P) to DU (P-p+1) from the latest one of the allocation time interval T(i) to the traffic amount prediction model created for the allocation time interval T(i) for each distributed station 13. The prediction unit 171 calculates the future traffic amount DU(i+1) of each distributed station 13 in the period D(i+1) from time t(i+1) to time t(i+2) (step S132). Note that t(i+2)=t(i+1)+T(i). The prediction unit 171 stores the calculated future traffic amount DU(i+1) of each distributed station 13.

In a case where the prediction time is equal to or longer than the allocation time T(i)+the switching time To (T(i)+Tc≤ the prediction time), the prediction unit 171 determines that the prediction of the future traffic amount is not possible by the end of the next period D(i) (step S131: NO). The prediction unit 171 performs the prediction from time t(i+1) to the time section T_req (for example, 5 ms) ahead that satisfies a service request delay. The prediction unit 171 sums the T_req/T(i) time-series predicted traffic amounts of the allocation time interval T(i) at a time in reverse chronological order for each distributed station 13 to calculate the time-series predicted traffic amounts in the time section T_req. The prediction unit 171 inputs q time-series predicted traffic amounts from the latest one of the time sections T_req to the traffic amount prediction model created for the time section T_req for each distributed station 13.

Thereby, the prediction unit 171 calculates a future traffic amount DUreq (i+1) of each distributed station 13 in the period D(i+1) from time t(i+1) to time t(i+2) (step S133). Note that t(i+2)=t(i+1)+T_req. The prediction unit 171 sets the future traffic amount DUreq (i+1) as the future traffic amount DU(i+1) calculated in step S114 of FIG. 5.

FIG. 8 is a flowchart illustrating upper link traffic amount prediction processing in the prediction unit 171. After the processing illustrated in the flowchart of FIG. 5, the prediction unit 171 executes upper link traffic amount prediction processing illustrated in the flowchart of FIG. 8. The traffic amount of the upper link between the aggregation station 14-n and the transfer apparatus 15 is the same as the traffic amount of the aggregation station 14-n. Therefore, first, the prediction unit 171 acquires bearer information received in advance by the switching instruction apparatus 17 from the aggregation station 14 (step S141). The bearer information is used as connection information indicating connection between the upper apparatus and the lower apparatus. The prediction unit 171 recognizes the connection relationship between the distributed station 13 and the aggregation station 14 by acquiring the bearer information.

The prediction unit 171 sums the future traffic amount DU(i+1) of the subordinate distributed stations 13 calculated in step S114 of FIG. 5 for each aggregation station 14. As a result, the prediction unit 171 calculates a future traffic amount L(i+1) that is the traffic amount in the period D(i+1) of the upper link connected to the aggregation station 14 (step S142). Specifically, the prediction unit 171 calculates the future traffic amount L(i+1) as follows.

$$Future traffic amount L ( i + 1 ) = Σ future traffic amount DU ( i + 1 ) \times if ( aggregation station - distributed station connection )$$

The above-described if (aggregation station-distributed station connection) is a flag that takes the value of 1 in a case where the aggregation station 14 is designated as the connection destination of the distributed station 13, and takes the value of 0 in a case where the aggregation station 14 is not designated. The prediction unit 171 outputs the period D(i+1) and the future traffic amount L(i+1) of each upper link to the switching threshold determination unit 172 and the switching determination unit 175 (step S143).

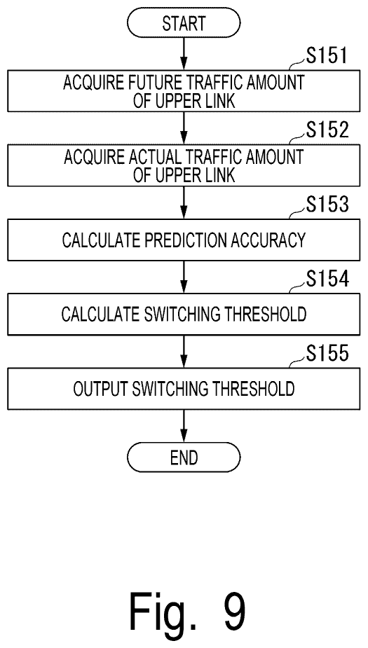

FIG. 9 is a flowchart illustrating switching threshold calculation processing in the switching threshold determination unit 172. Processing illustrated in the flowchart of FIG. 9 corresponds to the processing of step S4 of FIG. 4. The prediction accuracy calculation unit 173 receives information of the period D(a) and the future traffic amount L(a) of each upper link from the prediction unit 171 (step S151). These pieces of information correspond to the period D(i+1) and the future traffic amount L(i+1) of each upper link output by the prediction unit 171 in step S143 of FIG. 8.

Next, the prediction accuracy calculation unit 173 acquires the actual traffic amount of each distributed station 13 in the period D(a) (step S152). The prediction accuracy calculation unit 173 sums the actual traffic amounts in the period D(a) acquired in step S152 for the subordinate distributed stations 13 to calculate an actual traffic amount L′ (a) that is the actual traffic amount of the upper link connected to the aggregation station 14 for each aggregation station 14. Note that the prediction accuracy calculation unit 173 may receive the actual traffic amount L′ (a) in the period D(a) from the aggregation station 14.

The prediction accuracy calculation unit 173 acquires the link rate of each upper link. The prediction accuracy calculation unit 173 calculates the prediction accuracy in the period D(a) for each upper link (step S153). For example, the prediction accuracy calculation unit 173 calculates an error rate below as the prediction accuracy.

$$The error rate = \vert the future traffic amount L ( a ) - the actual traffic amount {L}^{′} ( a ) \vert \div ( the actual traffic amount {L}^{′} ( a ) ) \times 100$$

Alternatively, the prediction accuracy calculation unit 173 may obtain a root mean squared error (RMSE) or a mean absolute error (MAE) below used for evaluating the prediction accuracy. In the following expressions (1) and (2), fi represents the future traffic amount L(a), and yi represents the actual traffic amount L′ (a).

$$\begin{matrix}[ Math . 1 ] & \\ RMSE = \sqrt{\frac{1}{n} {\sum }_{k = 1}^{n} {( {f}_{i} - {y}_{i} )}^{2}} & ( 1 )\end{matrix}$$

$$\begin{matrix}[ Math . 2 ] & \\ MAE = \frac{1}{n} {\sum }_{k = 1}^{n} \vert {f}_{i} - {y}_{i} \vert & ( 2 )\end{matrix}$$

Next, the threshold calculation unit 174 calculates the switching threshold to be used in and after the period D(a) using the prediction accuracy calculated in step S153 (step S154). For example, in a case of calculating the error rate in step S153, the threshold calculation unit 174 calculates ae switching threshold TH of the upper link by the following expression (3).

$$Switching threshold TH = link rate \times ( 100 - error rate ) \div 100 \qquad ( 3 )$$

Alternatively, in a case of calculating the RMSE or the MAE in step S153 by the above-described expression (1) or expression (2), the threshold calculation unit 174 converts a lookup table stored in advance into the error rate.

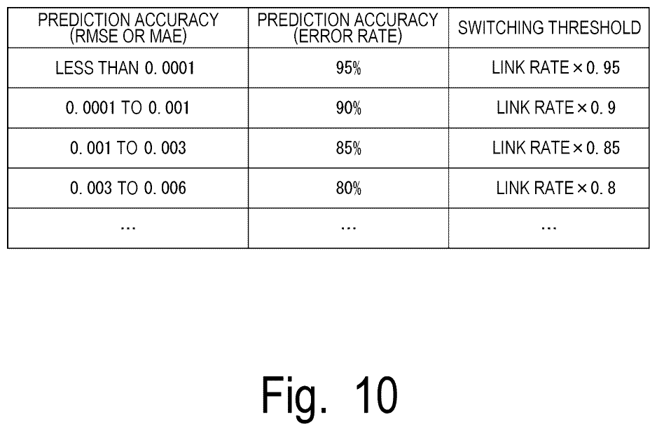

FIG. 10 is a table illustrating an example of the lookup table. The lookup table is data in which the prediction accuracy is associated with calculation formulas of the error rate and the switching threshold. The threshold calculation unit 174 reads the error rate corresponding to the prediction accuracy from the lookup table. The threshold calculation unit 174 calculates the switching threshold TH of each upper link by the above expression (3) using the read error rate.

In FIG. 9, the threshold calculation unit 174 outputs a switching threshold TH of each upper link calculated in step S154 to the switching determination unit 175 (step S155).

For example, a degree of accuracy or the like is used to calculate the prediction accuracy. However, it is uncertain whether or not the prediction accuracy is actually secured. In the present embodiment, the traffic amount is predicted in advance, and then the actual traffic flows. Therefore, as described above, the prediction accuracy is calculated using the difference between the actual traffic and the predicted traffic amount.

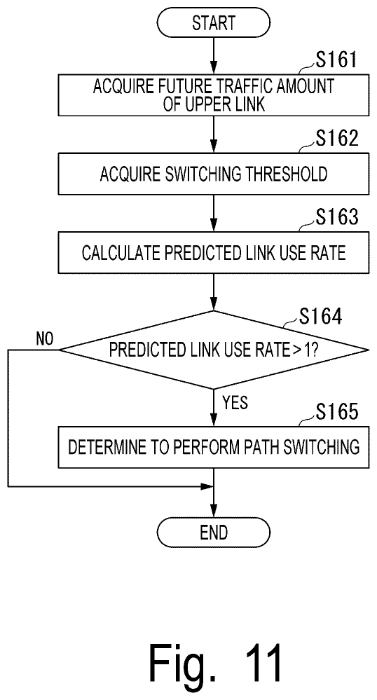

FIG. 11 is a flowchart illustrating switching determination processing in the switching determination unit 175. Processing of FIG. 11 corresponds to the processing of step S8 of FIG. 4. The switching determination unit 175 performs the processing illustrated in FIG. 11 for each upper link. The switching determination unit 175 receives the information of the period D(b) and the future traffic amount L(b) of each aggregation station 14 from the prediction unit 171 (step S161). These pieces of information correspond to the period D(i+1) and the future traffic amount L(i+1) of each aggregation station 14 output by the prediction unit 171 in step S143 of FIG. 8.

The switching determination unit 175 receives the switching threshold TH of each upper link output by the threshold calculation unit 174 in step S155 of FIG. 9 (step S162). The switching determination unit 175 calculates a predicted link use rate of each upper link by the following expression (4) using the switching threshold TH (step S163).

$$P redicted link use rate = future traffic amount L ( b ) / switching threshold TH \qquad ( 4 )$$

Note that the switching determination unit 175 converts the future traffic amount L(b) into the traffic amount per unit time equal to the link rate by, for example, dividing the future traffic amount L(b) by the length of the period D(b) before substituting the future traffic amount L(b) into the expression (4). The switching determination unit 175 determines whether or not the calculated predicted link use rate exceeds 1 (step S164). In a case of determining that the link use rate is equal to or less than 1 (that is, in a case of determining that the future traffic amount is equal to or less than the switching threshold), the switching determination unit 175 terminates the processing illustrated in the flowchart of FIG. 11 because of the prediction that congestion does not occur. On the other hand, in a case of determining that the predicted link use rate exceeds 1 (that is, the future traffic amount exceeds the switching threshold), the switching determination unit 175 determines to perform the path switching because occurrence of congestion is predicted (step S165).

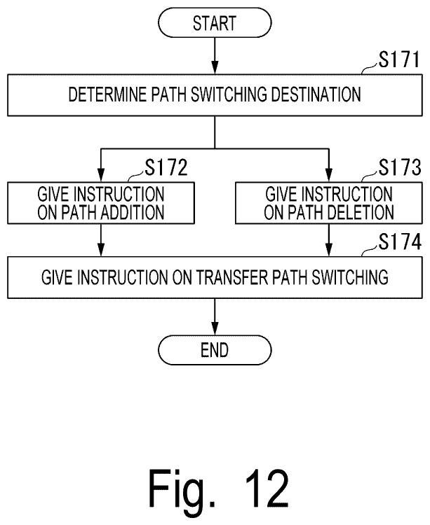

FIG. 12 is a flowchart illustrating switching determination processing in the switching determination unit 175. In a case of determining to perform the path switching in step S165 of FIG. 11, the switching determination unit 175 starts execution of the processing illustrated in the flowchart of FIG. 12.

The switching determination unit 175 acquires, from the prediction unit 171, the future traffic amount in the period D(b) of each upper link, the information of the distributed stations 13 subordinate to the aggregation station 14 connected to the upper link, and the future traffic amounts DU (b) of the distributed stations 13 in the period D(b). The switching determination unit 175 determines to switch the connection destination of one or more distributed stations 13 subordinate to the aggregation station 14 that uses the upper link having the predicted link use rate exceeding 1 to another aggregation station 14. At this time, the switching determination unit 175 determines the aggregation station 14 as the switching destination of the distributed stations 13 targeted for switching the connection destination so that the future traffic amount in each upper link becomes equal to or less than the switching threshold TH of the upper link, using the future traffic amount DU (b) of each distributed station 13 (step S171).

The switching determination unit 175 transmits a path addition instruction for adding the traffic of the distributed stations 13 targeted for switching the connection destination to the aggregation station 14 as the connection source (step S172). Further, the switching determination unit 175 transmits a path deletion instruction for deleting the traffic of the distributed stations 13 targeted for switching the connection destination to the aggregation station 14 as the switching source (step S173). Further, the switching determination unit 175 transmits a path switching instruction to instruct the transfer apparatus 15 to switch the communication path between the distributed stations 13 targeted for switching the connection destination and the aggregation station 14 as the switching source to the communication path between the distributed stations 13 targeted for switching the connection destination and the aggregation station 14 as the switching destination (step S174).

As described above, the communication system 1 and the mobile communication system 10, which are examples of the conventional communication system, predict the future traffic amount of the upper link in the period D(a), and calculate the prediction accuracy on the basis of the future traffic amount and the actual traffic amount. The communication system 1 and the mobile communication system 10 determine the switching threshold on the basis of the link rate of the upper link and the prediction accuracy. Then, the communication system 1 and the mobile communication system 10 predict the future traffic amount of the upper link in the period D(b) that is a period after the period D(a), and determine the necessity of the path switching on the basis of the switching threshold and the future traffic amount.

However, in an actual communication environment in which a plurality of flows having various traffic characteristics is mixed, for example, if the future traffic amounts of all the flows are collectively predicted, the prediction accuracy becomes low. On the other hand, if the future traffic amount is predicted for each flow, the calculation load related to the prediction increases and thus the path switching cannot be completed before congestion actually occurs. As described above, the conventional communication system cannot prevent the occurrence of congestion and may cause the communication delay even if the system performs the execution determination of the path switching on the basis of the prediction value of the traffic amount.

In contrast, a communication system in each embodiment of the present invention to be described below can reduce a calculation amount in prediction processing for a future traffic amount so that path switching is completed before congestion occurs.

Specifically, the communication system in each embodiment below has a configuration to group (classify) a plurality of flows to be predicted and determine a method of predicting a future traffic amount for each group. Furthermore, the communication system in each embodiment below has a configuration to predict the future traffic amount using linear prediction, which is a prediction method having a relatively small calculation amount, for a flow that is difficult to predict using machine learning, for example. Further, the communication system in each embodiment has a configuration to use a value of an immediately preceding traffic amount as an estimation result as it is without predicting the future traffic amount, for a flow with no change in the number of terminals or the like, among flows that can be predicted using machine learning, for example.

With such a configuration, the communication system in each embodiment of the present invention to be described below can reduce the calculation amount related to prediction of the future traffic amount. As a result, the communication system in each embodiment can suppress occurrence of congestion and reduce a communication delay while satisfying communication quality even in a general communication environment in which a plurality of flows is mixed.

### First Embodiment

Hereinafter, a communication system in a first embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the first embodiment is similar to the block diagram illustrating the functional configuration of the switching instruction apparatus 17 of the conventional communication system 1 illustrated in FIG. 3. Hereinafter, the switching instruction apparatus in the first embodiment will be referred to as a switching instruction apparatus 17a. The switching instruction apparatus 17a is, for example, an information processing apparatus such as a general-purpose computer. The switching instruction apparatus 17a of the present embodiment is different from the above-described conventional switching instruction apparatus 17 in a configuration of a prediction unit. Hereinafter, a configuration of a prediction unit 171a of the communication system in the present embodiment will be described.

### [Functional Configuration of Prediction Unit]

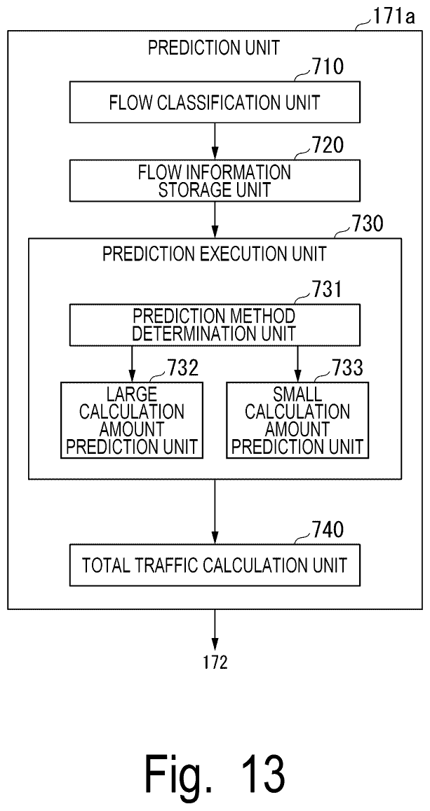

FIG. 13 is a block diagram illustrating a functional configuration of the prediction unit 171a of the communication system in the first embodiment of the present invention. As illustrated in FIG. 13, the prediction unit 171a includes a flow classification unit 710, a flow information storage unit 720, a prediction execution unit 730, and a total traffic calculation unit 740.

The flow classification unit 710 classifies flows input to the network 5 in a predetermined period (for example, 1 millisecond or 1 second, or the like) on the basis of characteristics of traffic. Here, the flow is a flow transmitted from a lower apparatus 3 to an upper apparatus 4 via the network 5.

In addition, here, flows of the same traffic pattern are defined as one flow. The flows of the same traffic pattern are, for example, flows having the same QoS. In addition, even the flows transmitted by the same lower apparatus 3 and upper apparatus 4 are defined as different flows when the traffic patterns are different (for example, if the Qos is different).

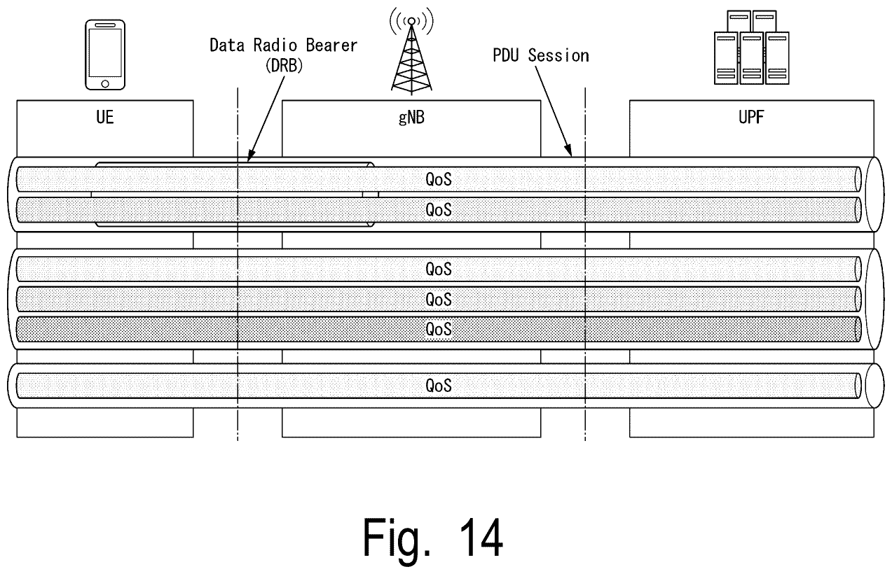

FIG. 14 is a schematic diagram for describing definition of a flow as a precondition in the first embodiment of the present invention. FIG. 14 illustrates a case where the number of terminals (UEs) that are the lower apparatuses 3 is three, and a thick cylinder represents a flow by each terminal. The flow by each terminal may include a plurality of flows of different traffic patterns (of different types of QoS).

In the top thick cylinder, flows of two types of traffic patterns are respectively represented by a thin cylinder hatched pale and a thin cylinder hatched medium pale. Further, in the middle thick cylinder, flows of three types of traffic patterns are respectively represented by a thin cylinder hatched pale, a thin cylinder hatched medium pale, and a thin cylinder hatched dark. Further, in the lower thick cylinder, only a flow of one type of traffic pattern is represented by a thin cylinder hatched pale.

For example, the thin cylinder hatched dark is moving image traffic at a frame rate of 60 frames per second (fps), the thin cylinder hatched medium pale is a flow of moving image traffic at the frame rate of 30 fps, the thin cylinder hatched pale is a flow of file transfer traffic by a file transfer protocol (FTP), and the like.

Here, it is assumed that the flows of the same traffic pattern (of the same QoS) have the same traffic characteristics (for example, traffic cycle or the like). The prediction unit 171a classifies the flows for each traffic pattern and predicts a future traffic amount.

The flow classification unit 710 classifies the flows according to the flow type based on information defined in, for example, 5G qos identifier (5Q1), sub network slice selection assist information (S-NSSAI), or the like. The flow classification unit 710 calculates the number of terminals and a total value of traffic amounts for each classified flow, and stores the calculated data in a flow information table stored in the flow information storage unit 720.

The flow information storage unit 720 include a storage medium, for example, a semiconductor memory such as a random access memory (RAM), an electrically erasable programmable read only memory (EEPROM), or a read only memory (ROM), a solid state drive (SSD) flash memory, a magnetic disk such as a hard disk drive (HDD), a storage medium (not illustrated) such as an optical disk, or any combination of these storage media.

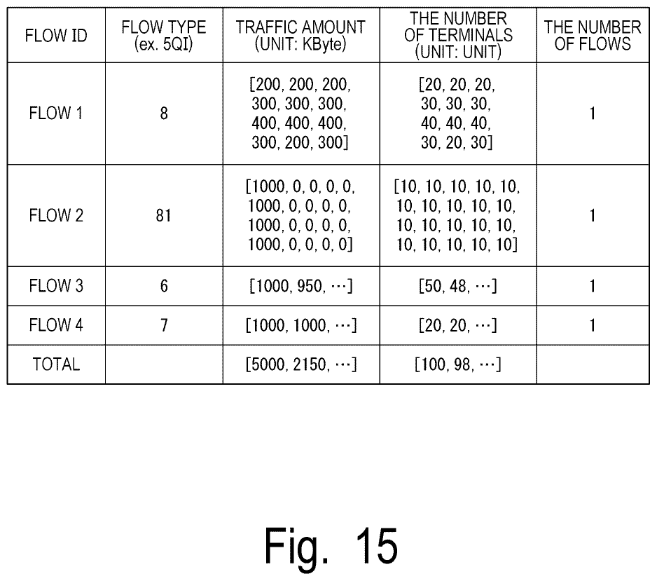

FIG. 15 is a table illustrating an example of a configuration of the flow information table in the first embodiment of the present invention. As illustrated in FIG. 15, for example, the flow information table is data in a table format in which a flow identifier (ID), a flow type, a traffic amount, the number of terminals, and the number of flows are associated with one another.

The flow ID is an identifier for identifying the classified flow. The flow type is a value representing a flow characteristic. In the flow information table illustrated in FIG. 15, a value of the flow type is a 5QI value. The traffic amount is a total value of the traffic amounts for each classified flow. In the flow information table illustrated in FIG. 15, the unit of the traffic amount is kilobytes. The number of terminals is a total value of the number of terminals for each classified flow. In the flow information table illustrated in FIG. 15, the unit of the number of terminals is unit.

The prediction execution unit 730 determines whether or not the future traffic amount is predictable for each flow grouped (classified) by the flow classification unit 710 using a prediction method with a relatively small calculation amount (hereinafter referred to as “small calculation amount prediction”). The prediction execution unit 730 predicts the future traffic amount using the small calculation amount prediction for the flow determined to be predictable using the small calculation amount prediction. Further, the prediction execution unit 730 predicts the future traffic amount using a prediction method with a relatively large calculation amount (hereinafter, referred to as “large calculation amount prediction”) for the flow that cannot be predicted using the small calculation amount prediction. The prediction execution unit 730 outputs a value of the future traffic amount predicted for each flow to the total traffic calculation unit 740.

The small calculation amount prediction is a simpler prediction method capable of predicting the future traffic amount with a relatively smaller calculation amount than the large calculation amount prediction. The small calculation amount prediction described here is, for example, a prediction method using linear prediction or the like. Furthermore, the large calculation amount prediction described here is, for example, a prediction method for performing prediction using machine learning or the like.

In contrast to the conventional switching instruction apparatus 17 that performs the large calculation amount prediction for all the flows to be predicted, the switching instruction apparatus 17a in the present embodiment has the configuration that uses the small calculation amount prediction for the flow for which the small calculation amount prediction can be used. Thereby, the switching instruction apparatus 17a in the present embodiment can reduce the calculation amount related to the prediction of the future traffic amount.

As illustrated in FIG. 13, the prediction execution unit 730 includes a prediction method determination unit 731, a large calculation amount prediction unit 732, and a small calculation amount prediction unit 733.

The prediction method determination unit 731 determines, for each flow grouped by the flow classification unit 710, whether or not the future traffic amount is predictable using the small calculation amount prediction on the basis of the traffic amount and the traffic pattern. More specifically, the prediction method determination unit 731 calculates a time-series variation of the traffic amount (burst of the traffic amount (burstiness)) for each flow grouped by the flow classification unit 710, and determines whether or not the future traffic amount is predictable using the small calculation amount prediction on the basis of a calculation result.

Note that the prediction method determination unit 731 may refer to the information stored in the flow information table illustrated in FIG. 15 described above, specify the traffic amount and the traffic pattern on the basis of the flow ID of each flow, and determine whether or not the prediction using the small calculation amount prediction is possible. In this case, the prediction method determination unit 731 specifies the flow ID on the basis of, for example, information regarding 5QI or S-NSSAI stored in the storage medium (not illustrated) included in the prediction unit 171a. Note that the information regarding 5QI or S-NSSAI may be stored in the flow information storage unit 720. The above-described storage medium (not illustrated) includes, for example, semiconductor memories such as a RAM, an EEPROM, and a ROM, a flash memory such as an SSD, a magnetic disk such as an HDD, a storage medium such as an optical disk, or an arbitrary combination of these storage media.

In a case of determining that the future traffic amount is predictable using the small calculation amount prediction, the prediction method determination unit 731 outputs the flow ID of the determined flow and the information indicating the current traffic amount to the small calculation amount prediction unit 733. On the other hand, in a case of determining that the future traffic amount is not predictable using the small calculation amount prediction, the prediction method determination unit 731 outputs the flow ID of the determined flow and the information indicating the current traffic amount to the large calculation amount prediction unit 732.

The large calculation amount prediction unit 732 predicts the future traffic amount using the large calculation amount prediction. The large calculation amount prediction unit 732 outputs a value of the future traffic amount predicted for each flow to the total traffic calculation unit 740.

The small calculation amount prediction unit 733 predicts the future traffic amount using the small calculation amount prediction. The small calculation amount prediction unit 733 outputs a value of the future traffic amount predicted for each flow to the total traffic calculation unit 740.

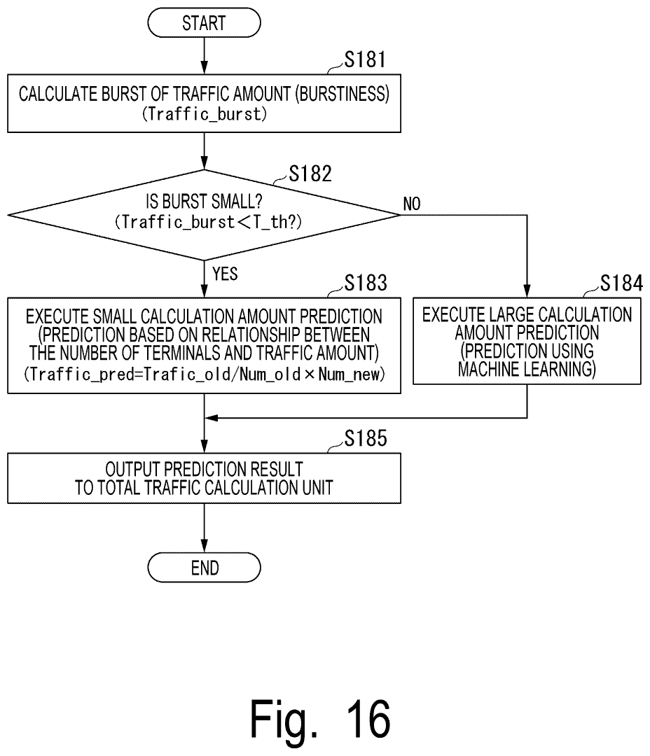

Hereinafter, the processing performed by the prediction execution unit 730 will be described in more detail with an example. FIG. 16 is a flowchart illustrating an operation of the prediction execution unit 730 of the communication system in the first embodiment of the present invention.

The prediction method determination unit 731 of the prediction execution unit 730 calculates a maximum value (Traffic burst) of a difference between the immediately preceding traffic amount and the current traffic amount for each flow classified by the flow classification unit 710. The prediction method determination unit 731 calculates the burst of the traffic amount (burstiness) on the basis of the calculated maximum value (Traffic burst) (step S181).

Note that the prediction method determination unit 731 may calculate the burst of the traffic amount (burstiness) on the basis of the traffic amount at the time of traffic transmission that can be acquired from the lower apparatus 3 and the 501 (or S-NSSAI). Alternatively, the prediction method determination unit 731 may acquire information indicating the burst of the traffic amount (burstiness) from a controller (not illustrated) of the lower apparatus 3.

Note that the prediction method determination unit 731 may calculate the burst of the traffic amount (burstiness) on the basis of a traffic allocation amount (TBS) that is a scheduling result of a wireless section instead of the traffic amount. Alternatively, the prediction method determination unit 731 may calculate the burst of the traffic amount (burstiness) on the basis of the traffic amount (or the traffic allocation amount) at the time of traffic transmission that can be acquired from a switch (SW), a remote terminal (RT), or the like installed between apparatuses (for example, between the lower apparatus 3 and the upper apparatus 4, or the like) and the DSCP.

Note that the configuration of the communication system in the present embodiment is not limited to the mobile network, and can also be applied to a network or the like via radio. In this case, the prediction method determination unit 731 may acquire the information indicating the traffic amount from a Wi-fi (registered trademark) access point or the like.

Next, the prediction method determination unit 731 determines whether or not the burst of the traffic amount is small. Specifically, the prediction method determination unit 731 determines whether or not the value of the maximum value (Traffic burst) of the difference between the previous traffic amount and the current traffic amount calculated in the above-described step S181 is smaller than a predetermined threshold (T_th) (step S182).

In a case of determining that the burst of the traffic amount is small (step S182: Yes), the prediction method determination unit 731 determines that the future traffic amount is predictable using the small calculation amount prediction. In a case of determining that the burst of the traffic amount is not small (step S182: No), the prediction method determination unit 731 determines that the future traffic amount is not predictable using the small calculation amount prediction.

Specific examples will be described below. For example, it is assumed that the time-series variation (traffic1_1, traffic1_2, . . . ) of the traffic amount (Traffic1) of Flow 1 is as the following expression (5).

$$Traffic 1 = [ traffic1\_ 1 , traffic1\_ 2 , … ] = [ 200 , 200 , … ] \qquad ( 5 )$$

At this time, traffic burst_1_2, which is a difference value between traffic1_1 and traffic1_2, is calculated as in the following expression (6).

$$traffic\_burst \_ 1 \_ 2 = abs ( traffic1\_ 2 - traffic1\_ 1 ) = 200 - 200 = 0 \qquad ( 6 )$$

Then, the sum of the difference values between traffic1_1 and the subsequent respective traffic amounts (traffic1_2+traffic1_3+ . . . +traffic1 N) is expressed as the following expression (7).

$$traffic\_bust \_ 1 = sum ( traffic\_bust1 \_ 2 + traffic\_bust1 \_ 3 + … + traffic\_bust1 \_N ) \qquad ( 7 )$$

Here, the value of N may be, for example, the maximum number of the time-series data of the traffic amount stored in the flow information storage unit 729, or may be an arbitrary number (for example, N=100). For example, in the case of N=10, the sum of the difference values between traffic1_1 and the respective subsequent traffic amounts is calculated as the following expression (8), for example, if the value of the traffic amount is the value of Flow 1 recorded in the flow information table illustrated in FIG. 15.

$$Traffic\_bust \_ 1 = sum ( traffic\_bust1 \_ 2 + traffic\_bust1 \_ 3 + … + traffic\_bust1 \_ 10 ) = 100 \qquad ( 8 )$$

The prediction method determination unit 731 compares the calculated value of Traffic_bust_1 with the predetermined threshold (T_th), for example, to determine magnitude of the burst of the traffic amount (burstiness) of Flow 1. Note that a predetermined fixed value may be set as the value of the threshold T_th, or a variation value such as a predetermined ratio with respect to the traffic amount (for example, 80% of the maximum value of the traffic amount of each flow) may be set as the value of the threshold T_th.

In a case where the burst of the traffic amount is small, it is possible to predict future traffic by the small calculation amount prediction by linear prediction or the like, for example. Therefore, in the case where the burst of the traffic amount is small, the prediction method determination unit 731 causes the small calculation amount prediction unit 733 to execute the small calculation amount prediction by linear prediction or the like, for example (step S183).

On the other hand, in a case where the burst of the traffic amount is not small, it is difficult to predict future traffic by the small calculation amount prediction by linear prediction or the like, for example. Therefore, in the case where the burst of the traffic amount is not small, the prediction method determination unit 731 causes the large calculation amount prediction unit 732 to execute the large calculation amount prediction using machine learning or the like, for example (step S184).

The large calculation amount prediction unit 732 performs the large calculation amount prediction (time-series prediction) in a case where the value of Traffic burst exceeds the threshold T_th as described above. Therefore, in this case, the large calculation amount prediction unit 732 first calculates a prediction cycle. Here, it is assumed that the value of the threshold T_th is set to, for example, the value of 80% of the maximum value of the traffic amount of each flow.

For example, in a case of Flow 1 described in the flow information table illustrated in FIG. 15, the maximum value of the traffic amount is 400 kilobytes. Therefore, the threshold (T_th_1) of Flow 1 is set as the following expression (9).

$$T\_th \_ 1 = 400 \times 0.8 = 320 \qquad ( 9 )$$

For example, as described above, in a case of Traffic_bust_1=100, Traffic_bust_1<T_th_1 is satisfied. Therefore, in this case, the prediction method determination unit 731 determines that it is possible to perform the small calculation amount prediction.

The small calculation amount prediction unit 733 predicts the future traffic amount (Traffic_pred) on the basis of the number of terminals and the traffic amount as in the following expression (10).

$$Traffic\_pred = Traffic\_old / Num\_old \times Num\_new \qquad ( 10 )$$

Here, Trafic_old represents a past traffic amount, Num old represents the past number of terminals, and Num new represents the current number of terminals.

For example, in the case of Flow 1 described in the flow information table illustrated in FIG. 15, the traffic amount in the first period is 200 kilobytes. Further, for example, in the case of Flow 1 described in the flow information table illustrated in FIG. 15, the numbers of terminals in both the first period and the subsequent period are twenty, and the number of terminals does not change. Therefore, in this case, the future traffic amount (Traffic_pred) is calculated as the following expression (11).

$$Traffic\_pred = 200 / 20 \times 20 = 200 \qquad ( 11 )$$

In this way, in the above case, the small calculation amount prediction unit 733 predicts that (the subsequent period of) the future traffic amount (Traffic_pred) of Flow 1 is 200 kilobytes.

The large calculation amount prediction unit 732 and the small calculation amount prediction unit 733 output the values of the future traffic amount for each flow, which is the prediction result, to the total traffic calculation unit 740 (step S185). Thus, the operation of the prediction execution unit 730 illustrated in the flowchart of FIG. 16 ends.

As illustrated in FIG. 13, the total traffic calculation unit 740 acquires the values of the future traffic amount for each flow output from the large calculation amount prediction unit 732 and the small calculation amount prediction unit 733, respectively. The total traffic calculation unit 740 adds up the acquired values of the future traffic amount to obtain a value of a total traffic amount (hereinafter referred to as “total traffic amount”). The total traffic calculation unit 740 outputs the calculated value of the total traffic amount to the switching threshold determination unit 172.

Processing after the value of the total traffic amount is output from the total traffic calculation unit 740 of the prediction unit 171a to the switching threshold determination unit 172 (that is, processing related to determination of execution of the path switching and processing related to execution control of the path switching) is similar to the processing in the conventional communication system 1, and thus description thereof is omitted. That is, processing in the subsequent stage after the processing by the prediction unit 171a is similar to the processing related to the control of the path switching by the switching threshold determination unit 172 and the switching determination unit 175 and the processing related to the path switching by the transfer apparatus 15 of the conventional communication system 1 described with reference to FIGS. 9 to 12 and the like, and thus description thereof is omitted.

As described above, the switching instruction apparatus 17a in the first embodiment of the present invention classifies each of the flows input from, for example, the lower apparatus 3 in the predetermined period on the basis of the characteristic of the traffic pattern (for example, Qos) based on the information defined in, for example, the 5QI or S-NSSAI. The switching instruction apparatus 17a calculates the burst of the traffic amount (burstiness) on the basis of the time-series variation (difference value) of the traffic amount for each classified flow. The switching instruction apparatus 17a determines whether or not the future traffic amount is predictable using the small calculation amount prediction for each flow on the basis of the calculated burst of the traffic amount (burstiness). As described above, the small calculation amount prediction is a prediction method with a relatively small calculation amount such as linear prediction.

The switching instruction apparatus 17a performs the small calculation amount prediction for the flow determined that the future traffic amount is predictable using the small calculation amount prediction. On the other hand, the switching instruction apparatus 17a performs the large calculation amount prediction for the flow determined that the future traffic amount is not predictable using the small calculation amount prediction. As described above, the large calculation amount prediction is a prediction method with a relatively large calculation amount, such as a prediction method using machine learning or the like. The switching instruction apparatus 17a adds the future traffic amounts calculated for the respective flows by the small calculation amount prediction or the large calculation amount prediction, and performs execution determination and execution control of the path switching on the basis of the total traffic amount.

As described above, the switching instruction apparatus 17a in the first embodiment of the present invention has the configuration to perform the prediction for each classified flow instead of collectively predicting all the flows in the prediction of the future traffic amount, thereby preventing deterioration in communication quality. Further, the switching instruction apparatus 17a in the first embodiment of the present invention is configured to perform the small calculation amount prediction such as linear prediction that can perform prediction with a smaller calculation amount without performing the large calculation amount prediction using, for example, machine learning or the like, for the flow determined that the future traffic amount is predictable using the small calculation amount prediction. With such a configuration, the switching instruction apparatus 17a can reduce the calculation amount in the prediction processing for the future traffic amount.

As a result, the switching instruction apparatus 17a can reduce a communication delay caused by incompletion of the prediction of the future traffic amount and the path switching before occurrence of congestion by reducing the calculation amount related to the prediction of the future traffic amount. As described above, the switching instruction apparatus 17a in the first embodiment of the present invention can reduce the communication delay while satisfying the communication quality even in a case where a plurality of flows is mixed.

### Second Embodiment

Hereinafter, a communication system in a second embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the second embodiment is similar to the block diagram illustrating the functional configuration of the switching instruction apparatus 17 of the conventional communication system 1 illustrated in FIG. 3. Hereinafter, the switching instruction apparatus in the second embodiment will be referred to as a switching instruction apparatus 17b. The switching instruction apparatus 17b is, for example, an information processing apparatus such as a general-purpose computer. The switching instruction apparatus 17b of the present embodiment is different from the above-described conventional switching instruction apparatus 17 in a configuration of a prediction unit. Hereinafter, a configuration of a prediction unit 171b of the communication system in the present embodiment will be described.

### [Functional Configuration of Prediction Unit]

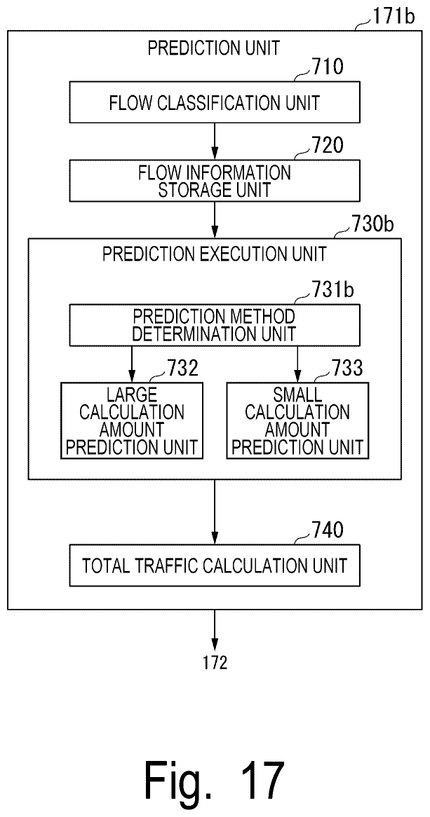

FIG. 17 is a block diagram illustrating a functional configuration of the prediction unit 171b of the communication system in a second embodiment of the present invention. As illustrated in FIG. 17, the prediction unit 171b includes a flow classification unit 710, a flow information storage unit 720, a prediction execution unit 730b, and a total traffic calculation unit 740.

The flow classification unit 710 classifies flows input to a network 5 in a predetermined period on the basis of characteristics of traffic, similarly to the above-described first embodiment. The flow classification unit 710 classifies the flows on the basis of a flow type based on information defined in, for example, 5QI, S-NSSAI, or the like. The flow classification unit 710 calculates the number of terminals and a total value of traffic amounts for each classified flow, and stores the calculated data in a flow information table stored in the flow information storage unit 720.

The prediction execution unit 730b determines whether or not a future traffic amount is predictable for each flow grouped (classified) by the flow classification unit 710 using small calculation amount prediction that is a prediction method with a relatively small calculation amount. The prediction execution unit 730b predicts the future traffic amount using the small calculation amount prediction for a flow determined that the future traffic amount is predictable using the small calculation amount prediction. Further, the prediction execution unit 730b predicts the future traffic amount using large calculation amount prediction that is a prediction method with a relatively large calculation amount for a flow determined that the future traffic amount is not predictable using the small calculation amount prediction. The prediction execution unit 730b outputs a value of the future traffic amount predicted for each flow to the total traffic calculation unit 740.

In contrast to the conventional switching instruction apparatus 17 that performs the large calculation amount prediction for all the flows to be predicted, the switching instruction apparatus 17b in the present embodiment has the configuration that uses the small calculation amount prediction for the flow for which the small calculation amount prediction can be used. Thereby, the switching instruction apparatus 17b in the present embodiment can reduce the calculation amount related to the prediction of the future traffic amount.

As illustrated in FIG. 17, the prediction execution unit 730b includes a prediction method determination unit 731b, a large calculation amount prediction unit 732, and a small calculation amount prediction unit 733.

The prediction method determination unit 731b determines, for each flow grouped by the flow classification unit 710, whether or not the future traffic amount is predictable using the small calculation amount prediction on the basis of a traffic amount and a traffic pattern. More specifically, the prediction method determination unit 731b calculates an average traffic amount for each flow grouped by the flow classification unit 710, and determines whether or not the future traffic amount is predictable using the small calculation amount prediction on the basis of a calculation result.

As described above, the prediction execution unit 730b in the present embodiment is different from the prediction execution unit 730 in the first embodiment in the configuration of the prediction method determination unit. The above-described prediction method determination unit 731 in the first embodiment has been configured to determine, for each flow, whether or not the future traffic amount is predictable using the small calculation amount prediction on the basis of the time-series variation of the traffic amount (burst of the traffic amount (burstiness)). In contrast, the prediction method determination unit 731b in the present embodiment is configured to determine, for each flow, whether or not the future traffic amount is predictable using the small calculation amount prediction on the basis of the average traffic amount.

In a case of determining that the future traffic amount is predictable using the small calculation amount prediction, the prediction method determination unit 731b outputs a flow ID of the determined flow and information indicating the current traffic amount to the small calculation amount prediction unit 733. On the other hand, in a case of determining that the prediction of the future traffic amount using the small calculation amount prediction is not possible, the prediction method determination unit 731b outputs the flow ID of the determined flow and the information indicating the current traffic amount to the large calculation amount prediction unit 732.

The large calculation amount prediction unit 732 predicts the future traffic amount using the large calculation amount prediction. The large calculation amount prediction unit 732 outputs a value of the future traffic amount predicted for each flow to the total traffic calculation unit 740.

The small calculation amount prediction unit 733 predicts the future traffic amount using the small calculation amount prediction. The small calculation amount prediction unit 733 outputs a value of the future traffic amount predicted for each flow to the total traffic calculation unit 740.

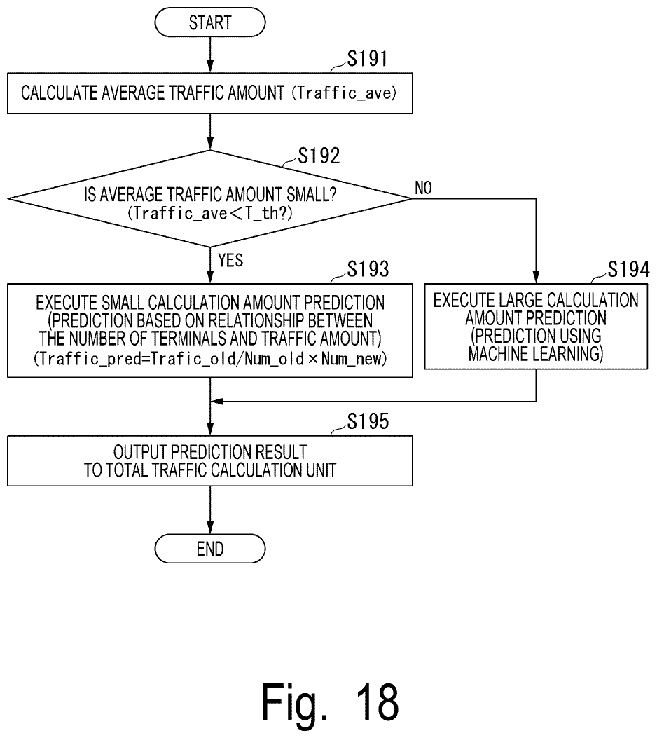

Hereinafter, the processing performed by the prediction execution unit 730b will be described in more detail with an example. FIG. 18 is a flowchart illustrating an operation of a prediction execution unit 730b of the communication system in the second embodiment of the present invention.

The prediction method determination unit 731b of the prediction execution unit 730b calculates the average traffic amount (Traffic_ave) in a predetermined period for each flow classified by the flow classification unit 710 (step S191).

Note that the configuration of the communication system in the present embodiment is not limited to the mobile network, and can also be applied to a network or the like via radio. In this case, the prediction method determination unit 731b may acquire the information indicating the traffic amount from a Wi-fi (registered trademark) access point or the like.

Next, the prediction method determination unit 731b determines whether or not the calculated average traffic amount is small. Specifically, the prediction method determination unit 731b determines whether or not the average traffic amount calculated in step S191 above is less than a predetermined threshold (T_th) (step S192).

In a case of determining that the average traffic amount is small (step S192: Yes), the prediction method determination unit 731b determines that the future traffic amount is predictable using the small calculation amount prediction. On the other hand, in a case of determining that the average traffic amount is not small (step S192: No), the prediction method determination unit 731b determines that the future traffic amount is not predictable using the small calculation amount prediction.

Specific examples will be described below. For example, it is assumed that the time-series variation (traffic1_1, traffic1_2, . . . ) of the traffic amount (Traffic1) of Flow 1 is as the following expression (12).

$$Traffic 1 = [ traffic 1 \_ 1 , traffic 1 \_ 2 , … ] = [ 200 , 200 , … ] \qquad ( 12 )$$

At this time, the average traffic amount of Flow 1 is calculated as in the following expression (13).

$$Traffic \_ave \_ 1 = ave ( traffic 1 \_ 1 + traffic 1 \_ 2 + … + traffic 1 \_N ) \qquad ( 13 )$$

Here, the value of N may be, for example, the maximum number of the time-series data of the traffic amount stored in the flow information storage unit 729, or may be an arbitrary number (for example, N=100). For example, in a case of N=10, the value of the average traffic amount (Traffic_ave_1) of Flow 1 is expressed by the following expression (14).

$$Traffic\_ave \_ 1 = ave ( traffic 1 \_ 1 + traffic 1 \_ 2 + … + traffic 1 \_ 10 ) = 300 \qquad ( 14 )$$

The prediction method determination unit 731b compares a calculated value of Traffic_ave_1 with the predetermined threshold (T_th), for example, to determine whether or not the average traffic amount of Flow 1 is small. Note that the value of the threshold T_th may be set as a predetermined fixed value (for example, 800 kilobytes or the like).

In a case where the average traffic amount is small, it is possible to predict the future traffic amount by the small calculation amount prediction by linear prediction or the like, for example. Therefore, in the case where the average traffic amount is small, the prediction method determination unit 731b causes the small calculation amount prediction unit 733 to execute the small calculation amount prediction by linear prediction or the like, for example (step S193).

On the other hand, in a case where the average traffic amount is not small, it is difficult to predict the future traffic amount by the small calculation amount prediction by linear prediction or the like, for example. Therefore, in the case where the average traffic amount is not small, the prediction method determination unit 731b causes the large calculation amount prediction unit 732 to execute the large calculation amount prediction using machine learning or the like, for example (step S194).

The large calculation amount prediction unit 732 performs the large calculation amount prediction (time-series prediction) in a case where the value of Traffic_ave exceeds the threshold T_th as described above. Therefore, in this case, the large calculation amount prediction unit 732 first calculates a prediction cycle. Here, it is assumed that the value of the threshold T_th is set to 800 kilobytes.

For example, as described above, in a case where Traffic_ave_1=300, the following expression (15) is established.

$$Traffic\_ave \_ 1 < T\_th \_ 1 \qquad ( 15 )$$

Therefore, in this case, the prediction method determination unit 731b determines to perform the small calculation amount prediction.

Note that, in the present embodiment, the prediction method determination unit 731b is configured to compare the average value of the traffic amount in the predetermined period with the predetermined threshold to determine the prediction method, but the present embodiment is not limited to this configuration. For example, the prediction method determination unit 731b may be configured to compare a maximum value of the traffic amount in a predetermined period with a predetermined threshold to determine the prediction method.

The small calculation amount prediction unit 733 predicts the future traffic amount (Traffic_pred) on the basis of the number of terminals and the traffic amount as in the following expression (16).

$$Traffic\_pred = Traffic\_old / Num\_old \times Num\_new \qquad ( 16 )$$

Here, Trafic_old represents a past traffic amount, Num old represents the past number of terminals, and Num new represents the current number of terminals.

For example, in the case of Flow 1 described in the flow information table illustrated in FIG. 15, the traffic amount in the first period is 200 kilobytes. Further, for example, in the case of Flow 1 described in the flow information table illustrated in FIG. 15, the numbers of terminals in both the first period and the subsequent period are twenty, and the number of terminals does not change. Therefore, in this case, the future traffic amount (Traffic_pred) is calculated as the following expression (17).

$$Traffic\_pred = 200 / 20 \times 20 = 200 \qquad ( 17 )$$

In this way, in the above case, the small calculation amount prediction unit 733 predicts that (the subsequent period of) the future traffic amount (Traffic_pred) of Flow 1 is 200 kilobytes.

The large calculation amount prediction unit 732 and the small calculation amount prediction unit 733 output the values of the future traffic amount for each flow, which is the prediction result, to the total traffic calculation unit 740 (step S195). Thus, the operation of the prediction execution unit 730b illustrated in the flowchart of FIG. 18 ends.

As illustrated in FIG. 17, the total traffic calculation unit 740 acquires the values of the future traffic amount for each flow output from the large calculation amount prediction unit 732 and the small calculation amount prediction unit 733. The total traffic calculation unit 740 adds up the acquired values of the future traffic amount to obtain a value of a total traffic amount. The total traffic calculation unit 740 outputs the calculated value of the total traffic amount to the switching threshold determination unit 172.

Processing after the value of the total traffic amount is output from the total traffic calculation unit 740 of the prediction unit 171b to the switching threshold determination unit 172 (that is, processing related to determination of execution of the path switching and processing related to execution control of the path switching) is similar to the processing in the conventional communication system 1, and thus description thereof is omitted. That is, processing in the subsequent stage after the processing by the prediction unit 171b is similar to the processing related to the control of the path switching by the switching threshold determination unit 172 and the switching determination unit 175 and the processing related to the path switching by the transfer apparatus 15 of the conventional communication system 1 described with reference to FIGS. 9 to 12 and the like, and thus description thereof is omitted.

As described above, the switching instruction apparatus 17b in the second embodiment of the present invention classifies each of the flows input from, for example, a lower apparatus 3 in a predetermined period on the basis of a characteristic of the traffic pattern (for example, Qos) based on information defined in, for example, the 5QI or S-NSSAI. The switching instruction apparatus 17b calculates the average traffic amount in the predetermined period for each classified flow. The switching instruction apparatus 17b determines, for each flow, whether or not the future traffic amount is predictable using the small calculation amount prediction that is a prediction method with a relatively small calculation amount such as linear prediction or the like on the basis of the calculated average traffic amount.

The switching instruction apparatus 17b performs the small calculation amount prediction for the flow determined that the future traffic amount is predictable using the small calculation amount prediction. On the other hand, the switching instruction apparatus 17b performs the large calculation amount prediction, which is a prediction method with a relatively large calculation amount, such as a prediction method using machine learning, for the flow determined that the future traffic amount is not predictable using the small calculation amount prediction. The switching instruction apparatus 17b adds the future traffic amounts calculated for the respective flows by the small calculation amount prediction or the large calculation amount prediction, and performs execution determination and execution control of the path switching on the basis of the total traffic amount.

As described above, the switching instruction apparatus 17b in the second embodiment of the present invention has the configuration to perform the prediction for each classified flow instead of collectively predicting all the flows in the prediction of the future traffic amount, thereby preventing deterioration in communication quality. Further, the switching instruction apparatus 17b in the second embodiment of the present invention is configured to perform the small calculation amount prediction such as linear prediction that can perform prediction with a smaller calculation amount without performing the large calculation amount prediction using, for example, machine learning or the like, for the flow determined that the future traffic amount is predictable using the small calculation amount prediction. With such a configuration, the switching instruction apparatus 17b can reduce the calculation amount in the prediction processing for the future traffic amount.

As a result, the switching instruction apparatus 17b can reduce the calculation amount related to the prediction of the future traffic amount and thus can reduce a communication delay caused by incompletion of the prediction of the future traffic amount and path switching before occurrence of congestion. As described above, the switching instruction apparatus 17b in the second embodiment of the present invention can reduce the communication delay while satisfying the communication quality even in a case where a plurality of flows is mixed.

### Third Embodiment

Hereinafter, a communication system in a third embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the third embodiment is similar to the block diagram illustrating the functional configuration of the switching instruction apparatus 17 of the conventional communication system 1 illustrated in FIG. 3. Hereinafter, the switching instruction apparatus in the third embodiment will be referred to as a switching instruction apparatus 17c. The switching instruction apparatus 17c is, for example, an information processing apparatus such as a general-purpose computer. The switching instruction apparatus 17c of the present embodiment is different from the above-described conventional switching instruction apparatus 17 in a configuration of a prediction unit. Hereinafter, a configuration of a prediction unit 171c of the communication system in the present embodiment will be described.

### [Functional Configuration of Prediction Unit]

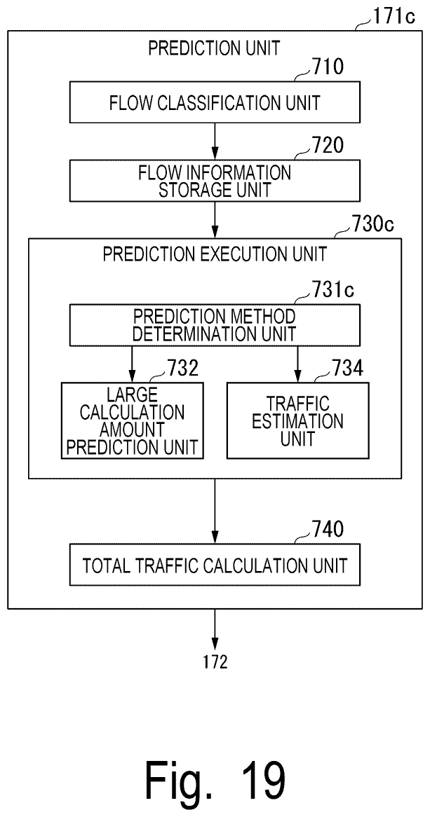

FIG. 19 is a block diagram illustrating a functional configuration of the prediction unit 171c of the communication system in the third embodiment of the present invention. As illustrated in FIG. 19, the prediction unit 171c includes a flow classification unit 710, a flow information storage unit 720, a prediction execution unit 730c, and a total traffic calculation unit 740.

The flow classification unit 710 classifies flows input to a network 5 in a predetermined period on the basis of characteristics of traffic, similarly to the above-described first embodiment. The flow classification unit 710 classifies the flows according to a flow type based on information defined in, for example, 5QI, S-NSSAI, or the like. The flow classification unit 710 calculates the number of terminals and a total value of traffic amounts for each classified flow, and stores the calculated data in a flow information table stored in the flow information storage unit 720.

The prediction execution unit 730c determines, for each flow grouped by the flow classification unit 710, whether or not estimation of a future traffic amount is possible using traffic estimation based on a variation in the number of terminals (hereinafter also simply referred to as “traffic estimation”) with a relatively small calculation amount. The prediction execution unit 730c estimates the future traffic amount using the traffic estimation for a flow determined that the future traffic amount can be estimated using the traffic estimation. Further, the prediction execution unit 730c predicts the future traffic amount using large calculation amount prediction that is a prediction method with a relatively large calculation amount for a flow determined that the future traffic amount cannot be estimated using the traffic estimation. The prediction execution unit 730c outputs a value of the future traffic amount predicted (or estimated) for each flow to the total traffic calculation unit 740.

In contrast to the conventional switching instruction apparatus 17 that performs the large calculation amount prediction for all the flows to be predicted, the switching instruction apparatus 17c in the present embodiment has the configuration that uses the traffic estimation for the flow for which the traffic estimation can be used. Thereby, the switching instruction apparatus 17c in the present embodiment can reduce the calculation amount related to the prediction of the future traffic amount.

As illustrated in FIG. 19, the prediction execution unit 730c includes a prediction method determination unit 731c, a large calculation amount prediction unit 732, and a traffic estimation unit 734.

The prediction method determination unit 731c determines whether or not the future traffic amount can be estimated using the traffic estimation for each flow grouped (classified) by the flow classification unit 710. More specifically, the prediction method determination unit 731c calculates the varied number of terminals for each flow grouped by the flow classification unit 710, and determines whether or not the future traffic amount can be estimated using the traffic estimation on the basis of a calculation result.

As described above, the prediction execution unit 730c in the present embodiment is different from the prediction execution unit 730 in the first embodiment and the prediction execution unit 730b in the second embodiment in the configuration of the prediction method determination unit. The above-described prediction method determination unit 731 in the first embodiment has been configured to determine, for each flow, whether or not the future traffic amount is predictable using the small calculation amount prediction on the basis of the time-series variation of the traffic amount (burst of the traffic amount (burstiness)). Further, the above-described prediction method determination unit 731b in the second embodiment has been configured to determine, for each flow, whether or not the future traffic amount is predictable using the small calculation amount prediction on the basis of the average traffic amount. In contrast, the prediction method determination unit 731c in the present embodiment is configured to determine whether or not the future traffic amount can be estimated using the traffic estimation on the basis of the varied number of terminals for each flow.

In a case where the number of terminals that has varied is zero (that is, in a case where the number of terminals has not varied), the prediction method determination unit 731c determines that the future traffic amount can be estimated using the traffic estimation, and outputs information indicating a flow ID of the determined flow and the current traffic amount to the traffic estimation unit 734. On the other hand, in a case where the number of terminals that has varied is one or more (that is, in a case where the number of terminals has varied), the prediction method determination unit 731c determines that the future traffic amount cannot be estimated using the traffic estimation, and outputs information indicating the flow ID of the determined flow and the current traffic amount to the large calculation amount prediction unit 732.

The large calculation amount prediction unit 732 predicts the future traffic amount using the large calculation amount prediction. The large calculation amount prediction unit 732 outputs a value of the future traffic amount predicted for each flow to the total traffic calculation unit 740.

The traffic estimation unit 734 estimates the future traffic amount using the traffic estimation. The traffic estimation unit 734 outputs a value of the future traffic amount estimated for each flow to the total traffic calculation unit 740.

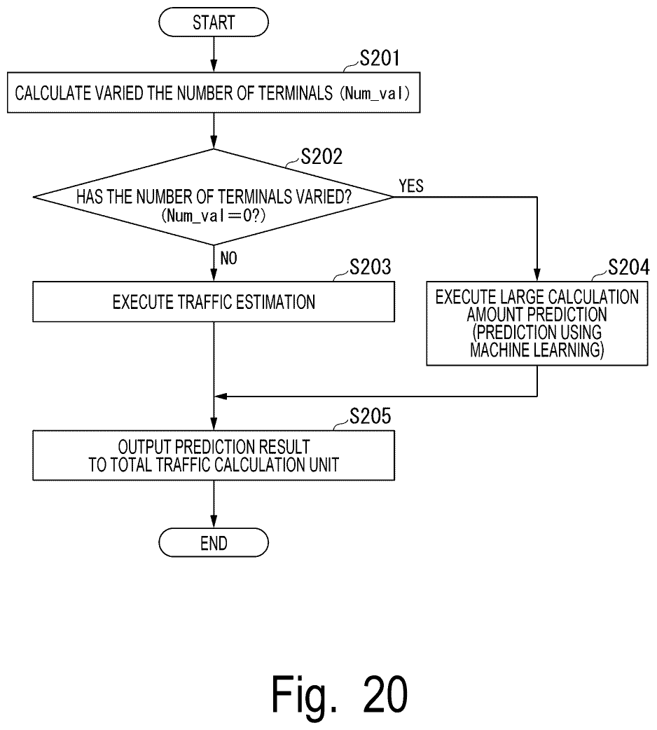

Hereinafter, the processing performed by the prediction execution unit 730c will be described in more detail with an example. FIG. 20 is a flowchart illustrating an operation of the prediction execution unit 730c of the communication system in the third embodiment of the present invention.

The prediction method determination unit 731c of the prediction execution unit 730c calculates the number of terminals (Num_val) that has varied in a predetermined period for each flow classified by the flow classification unit 710 (step S201).

Next, the prediction method determination unit 731c determines whether or not the number of terminals has varied. Specifically, the prediction method determination unit 731c determines whether or not the varied number of terminals (Num_val) calculated in step S201 above is zero (step S202).

In a case where it is determined that there is no variation in the number of terminals (step S202: Yes), the prediction method determination unit 731c determines that the future traffic amount can be estimated using the traffic estimation. On the other hand, in a case where it is determined that there is variation in the number of terminals (step S202: No), the prediction method determination unit 731c determines that the future traffic amount cannot be estimated using the traffic estimation.

Hereinafter, a more specific example will be described. For example, the prediction method determination unit 731c checks the presence or absence of variation in the number of terminals for an arbitrary period (R n). Note that a value of R n needs to be a sufficiently large value to include a traffic cycle.

For example, regarding the traffic of Flow 2 recorded in the flow information table illustrated in FIG. 15, variation in the number of terminals for ten periods is considered. The maximum value (Num_val_2) of the number of terminals that has varied in Flow 2 in the ten period is zero as in the following expression (18). This is because, as illustrated in FIG. 15, in Flow 2, the number of terminals remains unvaried at ten throughout the ten period.

$$Num\_val \_ 2 = max \{ ( num 2 \_ 2 - num 2 \_ 1 ) + ( num 2 \_ 3 - num 2 \_ 2 ) + … + ( num 2 \_ 11 - num 2 \_ 10 ) \} = 0 \qquad ( 18 )$$

As described above, for the flow with no variation in the number of terminals (Num_val=0), it is possible to estimate the future traffic amount by linear prediction or the like, for example. Therefore, in the case where there is no variation in the number of terminals, the prediction method determination unit 731c causes the traffic estimation unit 734 to execute estimation processing for the future traffic amount by linear prediction or the like, for example (step S203).

On the other hand, for the flow with variation in the number of terminals (Num_val>0), it is difficult to estimate the future traffic amount by linear prediction or the like, for example. Therefore, in the case where there is variation in the number of terminals, the prediction method determination unit 731c causes the large calculation amount prediction unit 732 to execute the large calculation amount prediction using machine learning or the like, for example (step S204).

The large calculation amount prediction unit 732 and the traffic estimation unit 734 output the value of the future traffic amount for each flow, which is a result of prediction (or estimation), to the total traffic calculation unit 740 (step S205). Thus, the operation of the prediction execution unit 730c illustrated in the flowchart of FIG. 20 ends.

As illustrated in FIG. 19, the total traffic calculation unit 740 acquires the values of the future traffic amount for each flow output from the large calculation amount prediction unit 732 and the traffic estimation unit 734. The total traffic calculation unit 740 adds up the acquired values of the future traffic amount to obtain a value of a total traffic amount. The total traffic calculation unit 740 outputs the calculated value of the total traffic amount to the switching threshold determination unit 172.

Processing after the value of the total traffic amount is output from the total traffic calculation unit 740 of the prediction unit 171c to the switching threshold determination unit 172 (that is, processing related to determination of execution of path switching and processing related to execution control of the path switching) is similar to the processing in the conventional communication system 1, and thus description thereof is omitted. That is, processing in the subsequent stage after the processing by the prediction unit 171c is similar to the processing related to the control of the path switching by the switching threshold determination unit 172 and the switching determination unit 175 and the processing related to the path switching by the transfer apparatus 15 of the conventional communication system 1 described with reference to FIGS. 9 to 12 and the like, and thus description thereof is omitted.

As described above, the switching instruction apparatus 17c in the third embodiment of the present invention classifies each of the flows input from, for example, a lower apparatus 3 in a predetermined period on the basis of a characteristic of a traffic pattern (for example, Qos) based on information defined in, for example, the 5QI or S-NSSAI. The switching instruction apparatus 17c calculates the number of terminals that has varied in a predetermined period for each classified flow. The switching instruction apparatus 17c determines whether or not the future traffic amount can be estimated using the traffic estimation such as linear prediction for each flow on the basis of the varied number of terminals.

The switching instruction apparatus 17c performs the traffic estimation for the flow determined that the future traffic amount can be estimated using the traffic estimation. On the other hand, the switching instruction apparatus 17c performs the large calculation amount prediction, which is a prediction method with a relatively large calculation amount, such as a prediction method using machine learning, for the flow determined that the future traffic amount cannot be estimated using the traffic estimation. The switching instruction apparatus 17c adds up the future traffic amounts calculated for the respective flows by the traffic estimation or the large calculation amount prediction, and performs execution determination and execution control of the path switching on the basis of the total traffic amount.

As described above, the switching instruction apparatus 17c in the third embodiment of the present invention has the configuration to perform the prediction for each classified flow instead of collectively predicting all the flows in the prediction of the future traffic amount, thereby preventing deterioration in communication quality. Further, the switching instruction apparatus 17c in the third embodiment of the present invention is configured to perform the traffic estimation such as linear prediction that can perform estimation with a smaller calculation amount without performing the large calculation amount prediction using, for example, machine learning or the like, for the flow determined that the future traffic amount can be estimated using the traffic estimation. With such a configuration, the switching instruction apparatus 17c can reduce the calculation amount in the prediction processing for the future traffic amount.

As a result, the switching instruction apparatus 17c can reduce the calculation amount related to the prediction of the future traffic amount and thus can reduce a communication delay caused by incompletion of the prediction of the future traffic amount and path switching before occurrence of congestion. As described above, the switching instruction apparatus 17c in the third embodiment of the present invention can reduce the communication delay while satisfying the communication quality even in a case where a plurality of flows is mixed.

### Fourth Embodiment

Hereinafter, a communication system in a fourth embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the fourth embodiment is similar to the block diagram illustrating the functional configuration of the switching instruction apparatus 17 of the conventional communication system 1 illustrated in FIG. 3. Hereinafter, the switching instruction apparatus in the fourth embodiment will be referred to as a switching instruction apparatus 17d. The switching instruction apparatus 17d is, for example, an information processing apparatus such as a general-purpose computer. The switching instruction apparatus 17d of the present embodiment is different from the above-described conventional switching instruction apparatus 17 in a configuration of a prediction unit. Hereinafter, a configuration of a prediction unit 171d of the communication system in the present embodiment will be described.

### [Functional Configuration of Prediction Unit]

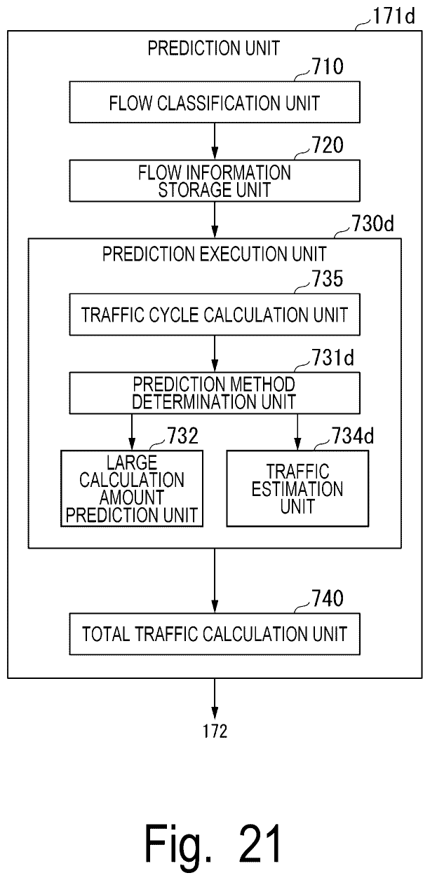

FIG. 21 is a block diagram illustrating a functional configuration of the prediction unit 171d of the communication system in the fourth embodiment of the present invention. As illustrated in FIG. 21, the prediction unit 171d includes a flow classification unit 710, a flow information storage unit 720, a prediction execution unit 730d, and a total traffic calculation unit 740.

The flow classification unit 710 classifies flows input to a network 5 in a predetermined period on the basis of characteristics of traffic, similarly to the above-described first embodiment. The flow classification unit 710 classifies the flows according to a flow type based on information defined in, for example, 5QI, S-NSSAI, or the like. The flow classification unit 710 calculates the number of terminals and a total value of traffic amounts for each classified flow, and stores the calculated data in a flow information table stored in the flow information storage unit 720.

The prediction execution unit 730d determines whether or not a future traffic amount can be estimated using traffic estimation with a relatively small calculation amount for each flow grouped by the flow classification unit 710. The prediction execution unit 730d estimates the future traffic amount using the traffic estimation for a flow determined that the future traffic amount can be estimated using the traffic estimation. Further, the prediction execution unit 730d predicts the future traffic amount using large calculation amount prediction that is a prediction method with a relatively large calculation amount for a flow determined that the future traffic amount cannot be estimated using the traffic estimation. The prediction execution unit 730d outputs a value of the future traffic amount predicted (or estimated) for each flow to the total traffic calculation unit 740.

In contrast to the conventional switching instruction apparatus 17 that performs the large calculation amount prediction for all the flows to be predicted, the switching instruction apparatus 17d in the present embodiment has a configuration that uses the traffic estimation for the flow for which the traffic estimation can be used, similarly to the above-described switching instruction apparatus 17c in the third embodiment. Thereby, the switching instruction apparatus 17d in the present embodiment can reduce a calculation amount related to the prediction of the future traffic amount.

As illustrated in FIG. 21, the prediction execution unit 730d includes a traffic cycle calculation unit 735, a prediction method determination unit 731d, a large calculation amount prediction unit 732, and a traffic estimation unit 734d. As described above, the prediction execution unit 730d in the present embodiment has the configuration in which the traffic cycle calculation unit 735 is added to the above-described prediction execution unit 730c in the third embodiment.

The traffic cycle calculation unit 735 calculates a traffic cycle of each flow. The traffic cycle calculation unit 735 outputs a calculated value of the traffic cycle of each flow to the prediction method determination unit 731d.

The traffic cycle calculation unit 735 specifies a traffic pattern of each flow on the basis of, for example, 5QI or S-NSSAI. The traffic cycle calculation unit 735 calculates the traffic cycle for each flow on the basis of the specified traffic pattern. Note that the traffic cycle calculation unit 735 may calculate the traffic cycle for each flow on the basis of a result of spectral analysis of time-series traffic.

The prediction method determination unit 731d acquires the value of the traffic cycle of each flow output from the traffic cycle calculation unit 735. The prediction method determination unit 731d determines whether or not the future traffic amount can be estimated using the traffic estimation for each flow grouped (classified) by the flow classification unit 710. More specifically, the prediction method determination unit 731d calculates the varied number of terminals for each flow grouped by the flow classification unit 710, and determines whether or not the future traffic amount can be estimated using the traffic estimation on the basis of a calculation result.

At this time, the prediction method determination unit 731d in the present embodiment calculates the number of terminals that has varied for each traffic cycle acquired from the traffic cycle calculation unit 735. As a result, for the flow with no variation in the number of terminals, the traffic estimation unit 734d to be described below can perform estimation using an algorithm for estimating the future traffic amount on the basis of variation in the traffic amount according to the traffic cycle. As a result, the prediction method determination unit 731d can perform the traffic estimation using the traffic cycle and thus can further narrow a range for checking the variation in the traffic amount (that is, can reduce the number of input data), and thus can further reduce the calculation amount in prediction processing for the future traffic amount.

Further, the prediction execution unit 730d in the present embodiment is different from the prediction execution unit 730 in the first embodiment and the prediction execution unit 730b in the second embodiment in the configuration of the prediction method determination unit, similarly to the prediction execution unit 730c in the third embodiment. The above-described prediction method determination unit 731 in the first embodiment has been configured to determine, for each flow, whether or not the future traffic amount is predictable using the small calculation amount prediction on the basis of the time-series variation of the traffic amount (burst of the traffic amount (burstiness)). Further, the above-described prediction method determination unit 731b in the second embodiment has been configured to determine, for each flow, whether or not the future traffic amount is predictable using the small calculation amount prediction on the basis of the average traffic amount. In contrast, the prediction method determination unit 731d in the present embodiment is configured to determine whether or not the future traffic amount can be estimated using the traffic estimation for each flow.

In a case where the number of terminals that has varied in the period of the traffic cycle is zero (that is, in a case where the number of terminals has not varied in the period of the traffic cycle), the prediction method determination unit 731d determines that the future traffic amount can be estimated using the traffic estimation, and outputs information indicating a flow ID of the determined flow and the current traffic amount to the traffic estimation unit 734d. On the other hand, in a case where the number of terminals that has varied in the period of the traffic cycle is one or more (that is, in a case where the number of terminals has varied in the period of the traffic cycle), the prediction method determination unit 731d determines that the future traffic amount cannot be estimated using the traffic estimation, and outputs the information indicating the flow ID of the determined flow and the current traffic amount to the large calculation amount prediction unit 732.

The large calculation amount prediction unit 732 predicts the future traffic amount using the large calculation amount prediction. The large calculation amount prediction unit 732 outputs a value of the future traffic amount predicted for each flow to the total traffic calculation unit 740.

The traffic estimation unit 734d estimates the future traffic amount using the traffic estimation. Here, the traffic estimation unit 734d performs the traffic estimation using the algorithm for estimating the future traffic amount on the basis of the variation in the traffic amount with the traffic cycle. The traffic estimation unit 734d outputs a value of the future traffic amount estimated for each flow to the total traffic calculation unit 740.

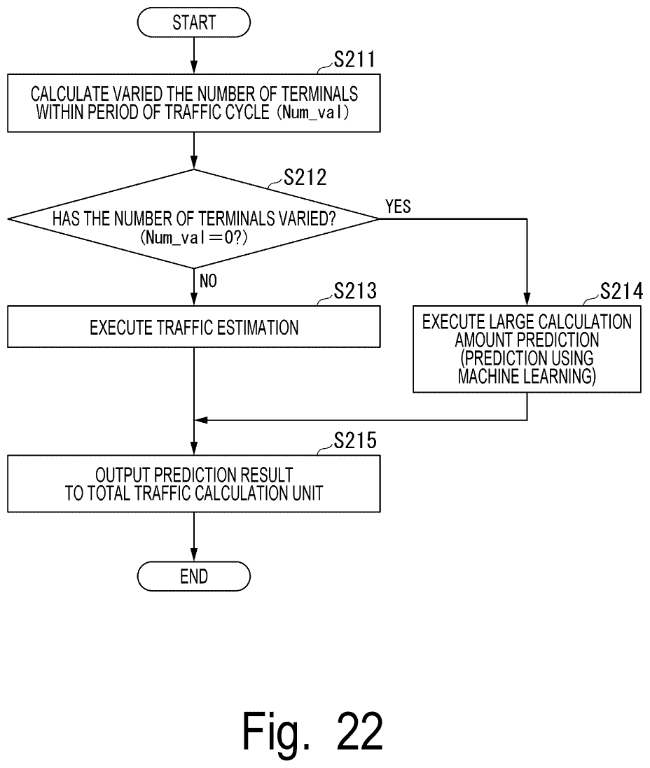

Hereinafter, the processing performed by the prediction execution unit 730d will be described in more detail with an example. FIG. 22 is a flowchart illustrating an operation of the prediction execution unit 730d of the communication system in the fourth embodiment of the present invention.

The traffic cycle calculation unit 735 of the prediction execution unit 730d calculates a traffic cycle of each flow. The traffic cycle calculation unit 735 outputs a calculated value of the traffic cycle of each flow to the prediction method determination unit 731d. The prediction method determination unit 731d acquires the value of the traffic cycle of each flow output from the traffic cycle calculation unit 735. The prediction method determination unit 731d calculates the number of terminals (Num_val) that has varied within the period of the traffic cycle for each flow classified by the flow classification unit 710 (step S211).

Next, the prediction method determination unit 731d determines whether or not the number of terminals has changed within the period of the traffic cycle. Specifically, the prediction method determination unit 731d determines whether or not the varied number of terminals (Num_val) calculated in step S211 above is zero (step S212).

In a case where it is determined that there is no variation in the number of terminals in the period of the traffic cycle (step S212: Yes), the prediction method determination unit 731d determines that the future traffic amount can be estimated using the traffic estimation. On the other hand, in a case where it is determined that there is variation in the number of terminals in the period of the traffic cycle (step S212: No), the prediction method determination unit 731c determines that the future traffic amount cannot be estimated using the traffic estimation.

Hereinafter, a more specific example will be described. For example, it is assumed that the traffic cycle (Traffic period) of Flow 2 recorded in the flow information table illustrated in FIG. 15 is five periods. In this case, the maximum value (Num_val_2) of the number of terminals that has varied in Flow 2 in the five period is zero as in the following expression (19). This is because, as illustrated in FIG. 15, in Flow 2, the number of terminals remains unvaried at five throughout the ten period.

$$Num\_val \_ 2 = max \{ ( num 2 \_ 2 - num 2 \_ 1 ) + ( num 2 \_ 3 - num 2 \_ 2 ) + … + ( num 2 \_ 6 - num 2 \_ 5 ) \} = 0 \qquad ( 19 )$$

As described above, for the flow with no variation in the number of terminals (Num_val=0), the prediction method determination unit 731d causes the traffic estimation unit 734d to perform, for example, the traffic estimation in which the traffic amount of one cycle before (that is, the traffic amount of five periods before) is set as an estimated value of the future traffic amount (step S213). That is, the estimated future traffic amount (T_pred) is expressed by the following expression (20).

$$T\_pred = Traffic\_ 2 \_ 0 = Traffic\_ 2 \_ 5 = 0 \qquad ( 20 )$$

On the other hand, for the flow with variation in the number of terminals (Num_val>0), it is difficult to estimate the future traffic amount by linear prediction or the like, for example. Therefore, in the case where there is variation in the number of terminals, the prediction method determination unit 731d causes the large calculation amount prediction unit 732 to execute the large calculation amount prediction using machine learning or the like (step S214).

The large calculation amount prediction unit 732 and the traffic estimation unit 734d output the value of the future traffic amount for each flow, which is a result of prediction (or estimation), to the total traffic calculation unit 740 (step S215). Thus, the operation of the prediction execution unit 730d illustrated in the flowchart of FIG. 22 ends.

As illustrated in FIG. 21, the total traffic calculation unit 740 acquires the values of the future traffic amount for each flow output from the large calculation amount prediction unit 732 and the traffic estimation unit 734d. The total traffic calculation unit 740 adds up the acquired values of the future traffic amount to obtain a value of a total traffic amount. The total traffic calculation unit 740 outputs the calculated value of the total traffic amount to the switching threshold determination unit 172.

Processing after the value of the total traffic amount is output from the total traffic calculation unit 740 of the prediction unit 171d to the switching threshold determination unit 172 (that is, processing related to determination of execution of path switching and processing related to execution control of the path switching) is similar to the processing in the conventional communication system 1, and thus description thereof is omitted. That is, processing in the subsequent stage after the processing by the prediction unit 171d is similar to the processing related to the control of the path switching by the switching threshold determination unit 172 and the switching determination unit 175 and the processing related to the path switching by the transfer apparatus 15 of the conventional communication system 1 described with reference to FIGS. 9 to 12 and the like, and thus description thereof is omitted.

As described above, the switching instruction apparatus 17d in the fourth embodiment of the present invention classifies each of the flows input from, for example, a lower apparatus 3 in a predetermined period on the basis of a characteristic of the traffic pattern (for example, Qos) based on information defined in, for example, the 5QI or S-NSSAI. The switching instruction apparatus 17d calculates the number of terminals that has varied within a predetermined period for each classified flow. The switching instruction apparatus 17d determines whether or not the future traffic amount can be estimated using the traffic estimation for each flow on the basis of the varied number of terminals.

At this time, the prediction method determination unit 731d in the present embodiment calculates the number of terminals that has varied for each traffic cycle acquired from the traffic cycle calculation unit 735. The prediction method determination unit 731d can perform the traffic estimation using the traffic cycle and thus can reduce the number of input data, and thus can further reduce the calculation amount in prediction processing for the future traffic amount.

The switching instruction apparatus 17d performs the traffic estimation for the flow determined that the future traffic amount can be estimated using the traffic estimation. On the other hand, the switching instruction apparatus 17d performs the large calculation amount prediction, which is a prediction method with a relatively large calculation amount, such as a prediction method using machine learning, for the flow determined that the future traffic amount cannot be estimated using the traffic estimation. The switching instruction apparatus 17d adds up the future traffic amounts calculated for the respective flows by the traffic estimation or the large calculation amount prediction, and performs execution determination and execution control of the path switching on the basis of the total traffic amount.

As described above, the switching instruction apparatus 17d in the fourth embodiment of the present invention has the configuration to perform the prediction for each classified flow instead of collectively predicting all the flows in the prediction of the future traffic amount, thereby preventing deterioration in communication quality. Further, the switching instruction apparatus 17d in the fourth embodiment of the present invention is configured to perform the traffic estimation such as linear prediction that can perform estimation with a smaller calculation amount without performing the large calculation amount prediction using, for example, machine learning or the like, for the flow determined that the future traffic amount can be estimated using the traffic estimation. With such a configuration, the switching instruction apparatus 17d can reduce the calculation amount in the prediction processing for the future traffic amount.

As a result, the switching instruction apparatus 17d can reduce the calculation amount related to the prediction of the future traffic amount and thus can reduce a communication delay caused by incompletion of the prediction of the future traffic amount and path switching before occurrence of congestion. As described above, the switching instruction apparatus 17d in the fourth embodiment of the present invention can reduce the communication delay while satisfying the communication quality even in a case where a plurality of flows is mixed.

### Fifth Embodiment

Hereinafter, a communication system in a fifth embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the fifth embodiment is similar to the block diagram illustrating the functional configuration of the switching instruction apparatus 17 of the conventional communication system 1 illustrated in FIG. 3. Hereinafter, the switching instruction apparatus in the fifth embodiment will be referred to as a switching instruction apparatus 17e. The switching instruction apparatus 17e is, for example, an information processing apparatus such as a general-purpose computer. The switching instruction apparatus 17e of the present embodiment is different from the above-described conventional switching instruction apparatus 17 in a configuration of a prediction unit. Hereinafter, a configuration of a prediction unit 171e of the communication system in the present embodiment will be described.

### [Functional Configuration of Prediction Unit]

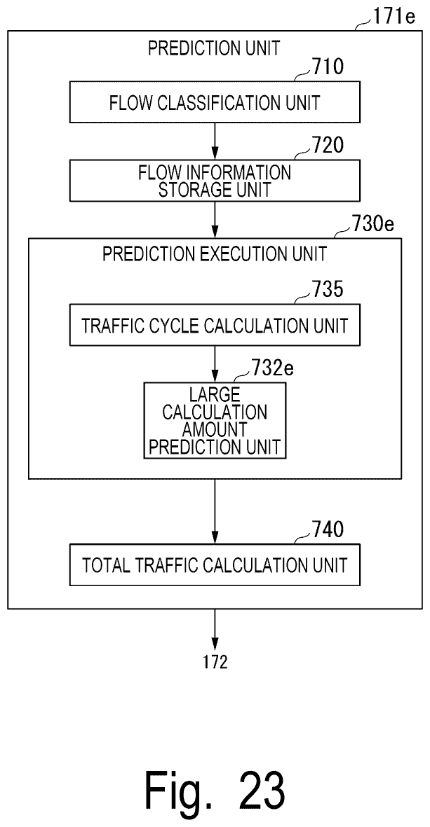

FIG. 23 is a block diagram illustrating a functional configuration of the prediction unit 171e of the communication system in the fifth embodiment of the present invention. As illustrated in FIG. 23, the prediction unit 171e includes a flow classification unit 710, a flow information storage unit 720, a prediction execution unit 730e, and a total traffic calculation unit 740.

The flow classification unit 710 classifies flows input to a network 5 in a predetermined period on the basis of characteristics of traffic, similarly to the above-described first embodiment. The flow classification unit 710 classifies the flows according to a flow type based on information defined in, for example, 5QI, S-NSSAI, or the like. The flow classification unit 710 calculates the number of terminals and a total value of traffic amounts for each classified flow, and stores the calculated data in a flow information table stored in the flow information storage unit 720.

The prediction execution unit 730e calculates a traffic cycle for each of the flows grouped by the flow classification unit 710, and predicts a future traffic amount using large calculation amount prediction for each traffic cycle. The prediction execution unit 730e outputs a value of the future traffic amount predicted for each flow to the total traffic calculation unit 740.

The switching instruction apparatus 17e in the present embodiment can reduce the number of input data to be used in prediction processing for the future traffic amount by setting the traffic cycle=the input data, and thus can reduce a calculation amount in the prediction processing.

As illustrated in FIG. 23, the prediction execution unit 730e includes a traffic cycle calculation unit 735 and a large calculation amount prediction unit 732e. As described above, the prediction execution unit 730e in the present embodiment has a configuration in which the prediction method determination unit 731d and the traffic estimation unit 734d are omitted from the prediction execution unit 730d in the above-described fourth embodiment.

The traffic cycle calculation unit 735 calculates a traffic cycle of each flow. The traffic cycle calculation unit 735 outputs a calculated value of the traffic cycle of each flow to the large calculation amount prediction unit 732e.

The traffic cycle calculation unit 735 specifies a traffic pattern of each flow on the basis of, for example, 5QI or S-NSSAI. The traffic cycle calculation unit 735 calculates the traffic cycle for each flow on the basis of the specified traffic pattern. Note that the traffic cycle calculation unit 735 may calculate the traffic cycle for each flow on the basis of a result of spectral analysis of time-series traffic.

The large calculation amount prediction unit 732e acquires the value of the traffic cycle of each flow output from the traffic cycle calculation unit 735. The large calculation amount prediction unit 732 predicts, for each traffic cycle, the future traffic amount using the large calculation amount prediction. The large calculation amount prediction unit 732 outputs a value of the future traffic amount predicted for each flow to the total traffic calculation unit 740.

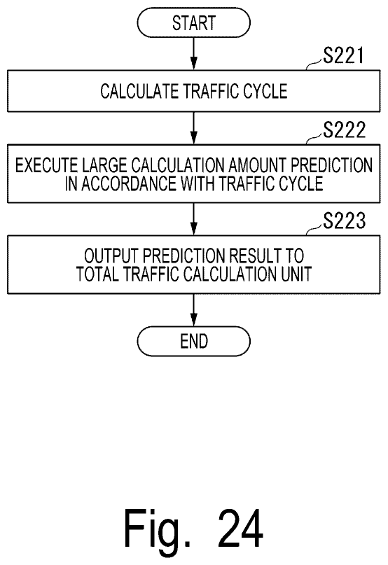

Hereinafter, processing performed by the prediction execution unit 730e will be described. FIG. 24 is a flowchart illustrating an operation of the prediction execution unit 730e of the communication system in the fifth embodiment of the present invention.

The traffic cycle calculation unit 735 of the prediction execution unit 730e calculates the traffic cycle of each flow (step S221). The traffic cycle calculation unit 735 outputs a calculated value of the traffic cycle of each flow to the large calculation amount prediction unit 732e. The large calculation amount prediction unit 732e acquires the value of the traffic cycle of each flow output from the traffic cycle calculation unit 735. The large calculation amount prediction unit 732 predicts, for each traffic cycle, the future traffic amount using the large calculation amount prediction (step S222). The large calculation amount prediction unit 732 outputs a value of the future traffic amount predicted for each flow to the total traffic calculation unit 740 (step S223).

Thus, the operation of the prediction execution unit 730e illustrated in the flowchart of FIG. 24 ends.

As illustrated in FIG. 23, the total traffic calculation unit 740 acquires the value of the future traffic amount for each flow output from the large calculation amount prediction unit 732. The total traffic calculation unit 740 adds up the acquired values of the future traffic amount to obtain a value of a total traffic amount. The total traffic calculation unit 740 outputs the calculated value of the total traffic amount to the switching threshold determination unit 172.

Processing after the value of the total traffic amount is output from the total traffic calculation unit 740 of the prediction unit 171e to the switching threshold determination unit 172 (that is, processing related to determination of execution of path switching and processing related to execution control of the path switching) is similar to the processing in the conventional communication system 1, and thus description thereof is omitted. That is, processing in the subsequent stage after the processing by the prediction unit 171e is similar to the processing related to the control of the path switching by the switching threshold determination unit 172 and the switching determination unit 175 and the processing related to the path switching by the transfer apparatus 15 of the conventional communication system 1 described with reference to FIGS. 9 to 12 and the like, and thus description thereof is omitted.

As described above, the switching instruction apparatus 17e in the fifth embodiment of the present invention classifies each of the flows input from, for example, a lower apparatus 3 in a predetermined period on the basis of a characteristic of the traffic pattern (for example, Qos) based on information defined in, for example, the 5QI or S-NSSAI. The switching instruction apparatus 17e performs the large calculation amount prediction, which is a prediction method with a relatively large calculation amount, such as a prediction method using machine learning, for each classified flow.

At this time, the prediction execution unit 730e calculates the traffic cycle for each of the flows grouped by the flow classification unit 710, and predicts the future traffic amount using the large calculation amount prediction for each traffic cycle. The switching instruction apparatus 17e can reduce the number of input data to be used in prediction processing for the future traffic amount by setting the traffic cycle=the input data, and thus can reduce the calculation amount in the prediction processing.

The switching instruction apparatus 17e adds the future traffic amounts calculated for the respective flows by the large calculation amount prediction, and performs execution determination and execution control of the path switching on the basis of the total traffic amount.

As described above, the switching instruction apparatus 17e in the fifth embodiment of the present invention has the configuration to perform the prediction for each classified flow instead of collectively predicting all the flows in the prediction of the future traffic amount, thereby preventing deterioration in communication quality. Further, the switching instruction apparatus 17e in the fifth embodiment of the present invention is configured to perform the large calculation amount prediction using, for example, machine learning for each traffic cycle. With such a configuration, the switching instruction apparatus 17e can reduce the number of input data and thus can reduce the calculation amount in the prediction processing for the future traffic amount.

As a result, the switching instruction apparatus 17e can reduce the calculation amount related to the prediction of the future traffic amount and thus can reduce a communication delay caused by incompletion of the prediction of the future traffic amount and path switching before occurrence of congestion. As described above, the switching instruction apparatus 17e in the fifth embodiment of the present invention can reduce the communication delay while satisfying the communication quality even in a case where a plurality of flows is mixed.

### Sixth Embodiment

Hereinafter, a communication system in a sixth embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the sixth embodiment is similar to the block diagram illustrating the functional configuration of the switching instruction apparatus 17 of the conventional communication system 1 illustrated in FIG. 3. Hereinafter, the switching instruction apparatus in the sixth embodiment will be referred to as a switching instruction apparatus 17f. The switching instruction apparatus 17f is, for example, an information processing apparatus such as a general-purpose computer. The switching instruction apparatus 17f of the present embodiment is different from the above-described conventional switching instruction apparatus 17 in a configuration of a prediction unit. Hereinafter, a configuration of a prediction unit 171f of the communication system in the present embodiment will be described.

### [Functional Configuration of Prediction Unit]

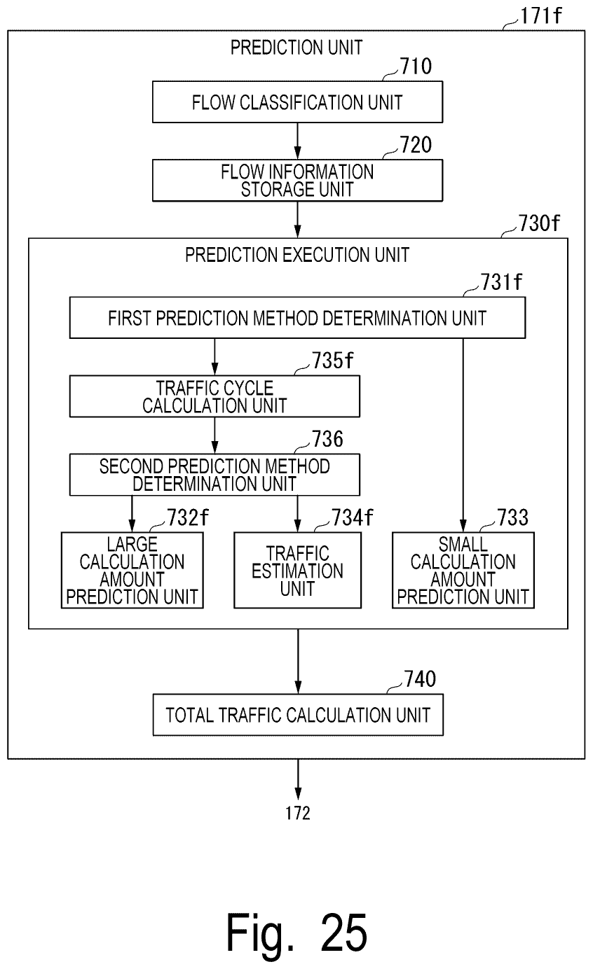

FIG. 25 is a block diagram illustrating a functional configuration of the prediction unit 171f of the communication system in the sixth embodiment of the present invention. As illustrated in FIG. 25, the prediction unit 171f includes a flow classification unit 710, a flow information storage unit 720, a prediction execution unit 730f, and a total traffic calculation unit 740.

The flow classification unit 710 classifies flows input to a network 5 in a predetermined period on the basis of characteristics of traffic, similarly to the above-described first embodiment. The flow classification unit 710 classifies the flows according to a flow type based on information defined in, for example, 5QI, S-NSSAI, or the like. The flow classification unit 710 calculates the number of terminals and a total value of traffic amounts for each classified flow, and stores the calculated data in a flow information table stored in the flow information storage unit 720.

The prediction execution unit 730f determines whether or not the future traffic amount is predictable for each flow grouped (classified) by the flow classification unit 710 using small calculation amount prediction that is a prediction method with a relatively small calculation amount. The prediction execution unit 730f predicts the future traffic amount using the small calculation amount prediction for the flow determined that the future traffic amount is predictable using the small calculation amount prediction. Further, the prediction execution unit 730f further determines whether or not the future traffic amount can be estimated using traffic estimation for the flow determined that the future traffic amount is not predictable using the small calculation amount prediction.

The prediction execution unit 730f estimates the future traffic amount using the traffic estimation for the flow determined that the future traffic amount can be estimated using the traffic estimation. Further, the prediction execution unit 730f predicts the future traffic amount using large calculation amount prediction that is a prediction method with a relatively large calculation amount for the flow determined that the future traffic amount cannot be estimated using the traffic estimation. The prediction execution unit 730f outputs a value of the future traffic amount predicted (or estimated) for each flow to the total traffic calculation unit 740.

In contrast to the conventional switching instruction apparatus 17 that performs the large calculation amount prediction for all the flows to be predicted, the switching instruction apparatus 17f in the present embodiment has a configuration using the small calculation amount prediction for the flow for which the small calculation amount prediction can be used and a configuration using the traffic estimation for the flow for which the traffic estimation can be used. Thereby, the switching instruction apparatus 17f in the present embodiment can reduce a calculation amount related to the prediction of the future traffic amount.

As illustrated in FIG. 25, the prediction execution unit 730f includes a first prediction method determination unit 731f, a traffic cycle calculation unit 735f, a second prediction method determination unit 736, a large calculation amount prediction unit 732f, a small calculation amount prediction unit 733, and a traffic estimation unit 734f.

Note that the configuration of the prediction execution unit 730f in the present embodiment is a combination of the configuration of the prediction execution unit 730 in the first embodiment illustrated in FIG. 13 described above and the configuration of the prediction execution unit 730d in the fourth embodiment illustrated in FIG. 21 described above.

Note that, for example, it is also possible to have a configuration in which the configuration of the prediction execution unit 730b in the second embodiment illustrated in FIG. 17 described above and the configuration of the prediction execution unit 730d in the fourth embodiment illustrated in FIG. 21 described above, a configuration in which the configuration of the prediction execution unit 730 in the first embodiment illustrated in FIG. 13 described above and the configuration of the prediction execution unit 730c in the third embodiment illustrated in FIG. 19 described above, or the like.

The first prediction method determination unit 731f determines, for each flow grouped by the flow classification unit 710, whether or not the future traffic amount is predictable using the small calculation amount prediction on the basis of a traffic amount and a traffic pattern. More specifically, the first prediction method determination unit 731f calculates a time-series variation of the traffic amount (burst of the traffic amount (burstiness)) for each flow grouped by the flow classification unit 710, and determines whether or not the future traffic amount is predictable using the small calculation amount prediction on the basis of a calculation result.

In a case of determining that the future traffic amount is predictable using the small calculation amount prediction, the first prediction method determination unit 731f outputs a flow ID of the determined flow and information indicating the current traffic amount to the small calculation amount prediction unit 733. On the other hand, in a case of determining that the prediction of the future traffic amount using the small calculation amount prediction is not possible, the prediction method determination unit 731 outputs the flow ID of the determined flow and the information indicating the current traffic amount to the traffic cycle calculation unit 735f.

The traffic cycle calculation unit 735 acquires the information indicating the current traffic amount output from the first prediction method determination unit 731f. The traffic cycle calculation unit 735 calculates a traffic cycle of each flow. The traffic cycle calculation unit 735 outputs the calculated value of the traffic cycle of each flow and information indicating the current traffic amount to the second prediction method determination unit 736.

The traffic cycle calculation unit 735f specifies a traffic pattern of each flow on the basis of, for example, 5QI or S-NSSAI. The traffic cycle calculation unit 735f calculates the traffic cycle for each flow on the basis of the specified traffic pattern. Note that the traffic cycle calculation unit 735f may calculate the traffic cycle for each flow on the basis of a result of spectral analysis of time-series traffic.

The second prediction method determination unit 736 acquires the value of the traffic cycle of each flow and the information indicating the current traffic amount output from the traffic cycle calculation unit 735f. The second prediction method determination unit 736 determines whether or not the future traffic amount can be estimated using the traffic estimation for each flow grouped (classified) by the flow classification unit 710. More specifically, the second prediction method determination unit 736 calculates the varied number of terminals for each flow grouped by the flow classification unit 710, and determines whether or not the future traffic amount can be estimated using the traffic estimation on the basis of a calculation result.

At this time, the second prediction method determination unit 736 in the present embodiment calculates the number of terminals that has varied for each traffic cycle acquired from the traffic cycle calculation unit 735f. As a result, for the flow with no variation in the number of terminals, the traffic estimation unit 734f to be described below can perform estimation using an algorithm for estimating the future traffic amount on the basis of variation in the traffic amount according to the traffic cycle. As a result, the second prediction method determination unit 736 can perform the traffic estimation using the traffic cycle and thus can narrow a range for checking the variation in the traffic amount (that is, can reduce the number of input data), and thus can further reduce the calculation amount in prediction processing for the future traffic amount.

In a case where the number of terminals that has varied in the period of the traffic cycle is zero (that is, in a case where the number of terminals has not varied in the period of the traffic cycle), the second prediction method determination unit 736 determines that the future traffic amount can be estimated using the traffic estimation, and outputs information indicating a flow ID of the determined flow and the current traffic amount to the traffic estimation unit 734f. On the other hand, in a case where the number of terminals that has varied in the period of the traffic cycle is one or more (that is, in a case where the number of terminals has varied in the period of the traffic cycle), the second prediction method determination unit 736 determines that the future traffic amount cannot be estimated using the traffic estimation, and outputs the information indicating the flow ID of the determined flow and the current traffic amount to the large calculation amount prediction unit 732f.

The large calculation amount prediction unit 732f predicts the future traffic amount using the large calculation amount prediction. The large calculation amount prediction unit 732f outputs a value of the future traffic amount predicted for each flow to the total traffic calculation unit 740.

The small calculation amount prediction unit 733 predicts the future traffic amount using the small calculation amount prediction. The small calculation amount prediction unit 733 outputs a value of the future traffic amount predicted for each flow to the total traffic calculation unit 740.

The traffic estimation unit 734f estimates the future traffic amount using the traffic estimation. Here, the traffic estimation unit 734f performs the traffic estimation using the algorithm for estimating the future traffic amount on the basis of the variation in the number of terminals within the traffic cycle. The traffic estimation unit 734f outputs a value of the future traffic amount estimated for each flow to the total traffic calculation unit 740.

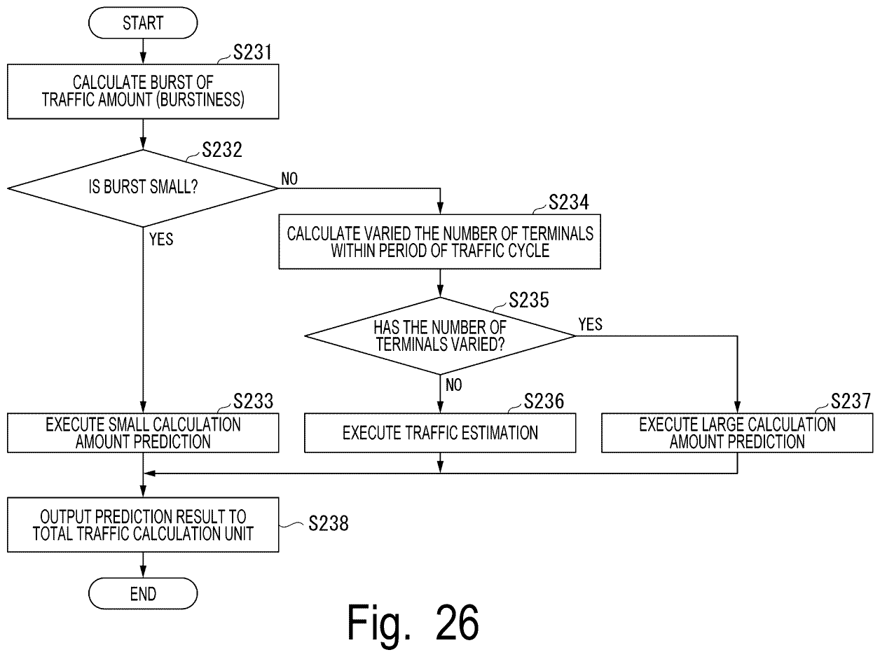

Hereinafter, processing performed by the prediction execution unit 730f will be described. FIG. 26 is a flowchart illustrating an operation of the prediction execution unit 730f of the communication system in the sixth embodiment of the present invention.

The first prediction method determination unit 731f of the prediction execution unit 730f calculates a maximum value of a difference between the immediately preceding traffic amount and the current traffic amount for each flow classified by the flow classification unit 710. The prediction method determination unit 731 calculates the burst of the traffic amount (burstiness) on the basis of the calculated maximum value (step S231).

Next, the first prediction method determination unit 731f determines whether or not the burst of the traffic amount is small. Specifically, the first prediction method determination unit 731f determines whether or not the value of the maximum value of the difference between the traffic amount one period before and the current traffic amount calculated in the above-described step S231 is smaller than a predetermined threshold (step S232).

In a case of determining that the burst of the traffic amount is small (step S232: Yes), the first prediction method determination unit 731f determines that the future traffic amount is predictable using the small calculation amount prediction. In this case, the small calculation amount prediction unit 733 predicts the future traffic amount using the small calculation amount prediction (step S233). The small calculation amount prediction unit 733 outputs a value of the future traffic amount predicted for each flow to the total traffic calculation unit 740 (step S238).

On the other hand, in a case of determining that the burst of the traffic amount is not small (step S232: No), the first prediction method determination unit 731f causes the traffic cycle calculation unit 735f to calculate the traffic cycle of each flow. The traffic cycle calculation unit 735f outputs a calculated value of the traffic cycle of each flow to the first prediction method determination unit 731f. The first prediction method determination unit 731f acquires the value of the traffic cycle of each flow output from the traffic cycle calculation unit 735f. The first prediction method determination unit 731f calculates the number of terminals that has varied within the period of the traffic cycle for each flow classified by the flow classification unit 710 (step S234).

Next, the second prediction method determination unit 736 determines whether or not the number of terminals has changed within the period of the traffic cycle. Specifically, the second prediction method determination unit 736 determines whether or not the varied number of terminals calculated in step S234 above is zero (step S235).

In a case where it is determined that there is no variation in the number of terminals in the period of the traffic cycle (step S235: No), the second prediction method determination unit 736 determines that the future traffic amount can be estimated using the traffic estimation. In this case, the traffic estimation unit 734f estimates the future traffic amount using the traffic estimation (step S236). The traffic estimation unit 734f outputs the value of the future traffic amount estimated for each flow to the total traffic calculation unit 740 (step S238).

On the other hand, in a case where it is determined that there is variation in the number of terminals in the period of the traffic cycle (step S235: Yes), the second prediction method determination unit 736 determines that the future traffic amount cannot be estimated using the traffic estimation. In this case, the large calculation amount prediction unit 732f predicts the future traffic amount using the large calculation amount prediction. The large calculation amount prediction unit 732f outputs a value of the future traffic amount predicted for each flow to the total traffic calculation unit 740 (step S238).

Thus, the operation of the prediction execution unit 730f illustrated in the flowchart of FIG. 26 ends.

As illustrated in FIG. 25, the total traffic calculation unit 740 acquires the values of the future traffic amount for each flow output from the large calculation amount prediction unit 732f, the small calculation amount prediction unit 733, and the traffic estimation unit 734f. The total traffic calculation unit 740 adds up the acquired values of the future traffic amount to obtain a value of a total traffic amount. The total traffic calculation unit 740 outputs the calculated value of the total traffic amount to the switching threshold determination unit 172.

Processing after the value of the total traffic amount is output from the total traffic calculation unit 740 of the prediction unit 171f to the switching threshold determination unit 172 (that is, processing related to determination of execution of path switching and processing related to execution control of the path switching) is similar to the processing in the conventional communication system 1, and thus description thereof is omitted. That is, processing in the subsequent stage after the processing by the prediction unit 171f is similar to the processing related to the control of the path switching by the switching threshold determination unit 172 and the switching determination unit 175 and the processing related to the path switching by the transfer apparatus 15 of the conventional communication system 1 described with reference to FIGS. 9 to 12 and the like, and thus description thereof is omitted.

As described above, the switching instruction apparatus 17f in the sixth embodiment of the present invention classifies each of the flows input from, for example, a lower apparatus 3 in a predetermined period on the basis of a characteristic of the traffic pattern (for example, Qos) based on information defined in, for example, the 5QI or S-NSSAI. The switching instruction apparatus 17f calculates the burst of the traffic amount (burstiness) on the basis of the time-series variation (difference value) of the traffic amount for each classified flow. The switching instruction apparatus 17f determines, for each flow, whether or not the future traffic amount is predictable using the small calculation amount prediction that is a prediction method with a relatively small calculation amount such as linear prediction or the like on the basis of the calculated burst of the traffic amount (burstiness).

The switching instruction apparatus 17f performs the small calculation amount prediction for the flow determined that the future traffic amount is predictable using the small calculation amount prediction. Meanwhile, the switching instruction apparatus 17f determines whether or not the future traffic amount can be estimated using traffic estimation for the flow determined that the future traffic amount is not predictable using the small calculation amount prediction.

At this time, the prediction method determination unit 731d in the present embodiment calculates the number of terminals that has varied for each traffic cycle acquired from the traffic cycle calculation unit 735. The prediction method determination unit 731d can perform the traffic estimation using the traffic cycle and thus can reduce the number of input data, and thus can further reduce the calculation amount in prediction processing for the future traffic amount.

The switching instruction apparatus 17f performs the traffic estimation for the flow determined that the future traffic amount can be estimated using the traffic estimation. On the other hand, the switching instruction apparatus 17f performs the large calculation amount prediction, which is a prediction method with a relatively large calculation amount, such as a prediction method using machine learning, for the flow determined that the future traffic amount cannot be estimated using the traffic estimation. The switching instruction apparatus 17f adds up the future traffic amounts calculated for the respective flows by the large calculation amount prediction, the small calculation amount prediction, or the traffic estimation, and performs execution determination and execution control of the path switching on the basis of the total traffic amount.

As described above, the switching instruction apparatus 17f in the sixth embodiment of the present invention has the configuration to perform the prediction for each classified flow instead of collectively predicting all the flows in the prediction of the future traffic amount, thereby preventing deterioration in communication quality. Further, the switching instruction apparatus 17f in the sixth embodiment of the present invention is configured to perform the small calculation amount prediction such as linear prediction that can perform prediction with a smaller calculation amount without performing the large calculation amount prediction using, for example, machine learning or the like, for the flow determined that the future traffic amount is predictable using the small calculation amount prediction. Moreover, the switching instruction apparatus 17f in the sixth embodiment of the present invention is configured to perform the traffic estimation that can perform estimation with a smaller calculation amount without performing the large calculation amount prediction using, for example, machine learning or the like, for the flow determined that the future traffic amount can be estimated using the traffic estimation. With such a configuration, the switching instruction apparatus 17f can reduce the calculation amount in the prediction processing for the future traffic amount.

As a result, the switching instruction apparatus 17f can reduce the calculation amount related to the prediction of the future traffic amount and thus can reduce a communication delay caused by incompletion of the prediction of the future traffic amount and path switching before occurrence of congestion. As described above, the switching instruction apparatus 17f in the sixth embodiment of the present invention can reduce the communication delay while satisfying the communication quality even in a case where a plurality of flows is mixed.

As a result, the switching instruction apparatus 17f can reduce the calculation amount related to the prediction of the future traffic amount and thus can reduce a communication delay caused by incompletion of the prediction of the future traffic amount and path switching before occurrence of congestion. As described above, the switching instruction apparatus 17f in the sixth embodiment of the present invention can reduce the communication delay while satisfying the communication quality even in a case where a plurality of flows is mixed.

### Seventh Embodiment

Hereinafter, a communication system in a seventh embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the seventh embodiment is similar to the block diagram illustrating the functional configuration of the switching instruction apparatus 17 of the conventional communication system 1 illustrated in FIG. 3. Hereinafter, the switching instruction apparatus in the seventh embodiment will be referred to as a switching instruction apparatus 17g. The switching instruction apparatus 17g is, for example, an information processing apparatus such as a general-purpose computer. The switching instruction apparatus 17g of the present embodiment is different from the above-described conventional switching instruction apparatus 17 in configurations of a prediction unit, a switching threshold determination unit, and a switching determination unit. Hereinafter, configurations of a prediction unit 171g, a switching threshold determination unit 172g, and a switching determination unit 175g of the communication system in the present embodiment will be described.

### [Functional Configuration of Prediction Unit]

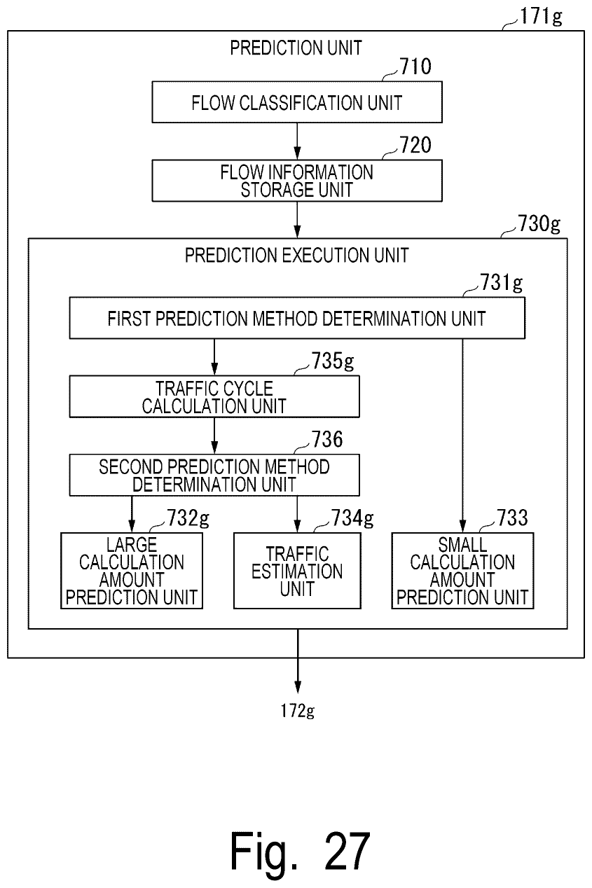

FIG. 27 is a block diagram illustrating a functional configuration of the prediction unit 171g of the communication system in the seventh embodiment of the present invention. As illustrated in FIG. 27, the prediction unit 171g includes a flow classification unit 710, a flow information storage unit 720, and a prediction execution unit 730g.

The flow classification unit 710 classifies flows input to a network 5 in a predetermined period on the basis of characteristics of traffic, similarly to the above-described first embodiment. The flow classification unit 710 classifies the flows according to a flow type based on information defined in, for example, 5QI, S-NSSAI, or the like. The flow classification unit 710 calculates the number of terminals and a total value of traffic amounts for each classified flow, and stores the calculated data in a flow information table stored in the flow information storage unit 720.

The prediction execution unit 730g determines whether or not the future traffic amount is predictable for each flow grouped (classified) by the flow classification unit 710 using small calculation amount prediction that is a prediction method with a relatively small calculation amount. The prediction execution unit 730g predicts the future traffic amount using the small calculation amount prediction for the flow determined that the future traffic amount is predictable using the small calculation amount prediction. Further, the prediction execution unit 730g further determines whether or not the future traffic amount can be estimated using traffic estimation for the flow determined that the future traffic amount is not predictable using the small calculation amount prediction.

The prediction execution unit 730g estimates the future traffic amount using the traffic estimation for the flow determined that the future traffic amount can be estimated using the traffic estimation. Further, the prediction execution unit 730g predicts the future traffic amount using large calculation amount prediction that is a prediction method with a relatively large calculation amount for the flow determined that the future traffic amount cannot be estimated using the traffic estimation. The prediction execution unit 730g outputs a value of the future traffic amount predicted (or estimated) for each flow to the total traffic calculation unit 740.

As illustrated in FIG. 27, the prediction execution unit 730g includes a first prediction method determination unit 731g, a traffic cycle calculation unit 735g, a second prediction method determination unit 736, a large calculation amount prediction unit 732g, a small calculation amount prediction unit 733, and a traffic estimation unit 734g.

The first prediction method determination unit 731g determines, for each flow grouped (classified) by the flow classification unit 710, whether or not the future traffic amount is predictable using the small calculation amount prediction on the basis of a traffic amount and a traffic pattern. More specifically, the first prediction method determination unit 731g calculates a time-series variation of the traffic amount (burst of the traffic amount (burstiness)) for each flow grouped by the flow classification unit 710, and determines whether or not the future traffic amount is predictable using the small calculation amount prediction on the basis of a calculation result.

In a case of determining that the future traffic amount is predictable using the small calculation amount prediction, the first prediction method determination unit 731g outputs a flow ID of the determined flow and information indicating the current traffic amount to the small calculation amount prediction unit 733. On the other hand, in a case of determining that the prediction of the future traffic amount using the small calculation amount prediction is not possible, the first prediction method determination unit 731g outputs the flow ID of the determined flow and the information indicating the current traffic amount to the traffic cycle calculation unit 735g.

The traffic cycle calculation unit 735g acquires the information indicating the current traffic amount output from the first prediction method determination unit 731g. The traffic cycle calculation unit 735g calculates a traffic cycle of each flow. The traffic cycle calculation unit 735g outputs the calculated value of the traffic cycle of each flow and information indicating the current traffic amount to the second prediction method determination unit 736.

The second prediction method determination unit 736 acquires the value of the traffic cycle of each flow and the information indicating the current traffic amount output from the traffic cycle calculation unit 735g. The second prediction method determination unit 736 determines whether or not the future traffic amount can be estimated using the traffic estimation for each flow grouped (classified) by the flow classification unit 710. More specifically, the second prediction method determination unit 736 calculates the varied number of terminals for each flow grouped by the flow classification unit 710, and determines whether or not the future traffic amount can be estimated using the traffic estimation on the basis of a calculation result.

At this time, the second prediction method determination unit 736 in the present embodiment calculates the number of terminals that has varied for each traffic cycle acquired from the traffic cycle calculation unit 735g. In a case where the number of terminals that has varied in the period of the traffic cycle is zero (that is, in a case where the number of terminals has not varied in the period of the traffic cycle), the second prediction method determination unit 736 determines that the future traffic amount can be estimated using the traffic estimation, and outputs information indicating a flow ID of the determined flow and the current traffic amount to the traffic estimation unit 734g.

On the other hand, in a case where the number of terminals that has varied in the period of the traffic cycle is one or more (that is, in a case where the number of terminals has varied in the period of the traffic cycle), the second prediction method determination unit 736 determines that the future traffic amount cannot be estimated using the traffic estimation, and outputs the information indicating the flow ID of the determined flow and the current traffic amount to the large calculation amount prediction unit 732g.

The large calculation amount prediction unit 732g predicts the future traffic amount using the large calculation amount prediction. The large calculation amount prediction unit 732g outputs a value of the future traffic amount predicted for each flow to the total traffic calculation unit 740g of the switching threshold determination unit 172g to be described below.

The small calculation amount prediction unit 733 predicts the future traffic amount using the small calculation amount prediction. The small calculation amount prediction unit 733 outputs the value of the future traffic amount predicted for each flow to the total traffic calculation unit 740g of the switching threshold determination unit 172g to be described below.

The traffic estimation unit 734g estimates the future traffic amount using the traffic estimation. Here, the traffic estimation unit 734f performs the traffic estimation using the algorithm for estimating the future traffic amount on the basis of the variation in the traffic amount with the traffic cycle. The traffic estimation unit 734g outputs the value of the future traffic amount estimated for each flow to the total traffic calculation unit 740g of the switching threshold determination unit 172g to be described below.

The above-described prediction units of the first to sixth embodiments have included the total traffic calculation unit 740, and the large calculation amount prediction unit, the small calculation amount prediction unit, and the traffic prediction unit have been configured to output the predicted (or estimated) value of the predicted future traffic amount to the total traffic calculation unit 740. Then, the total traffic calculation unit 740 has been configured to acquire and add up the values of the future traffic amounts, and output the value of the total traffic amount to the switching threshold determination unit.

In contrast, in the seventh embodiment, the prediction unit 171g does not include a total traffic calculation unit 740, and instead, the switching threshold determination unit 172g to be described below includes a total traffic calculation unit 740g.

The above-described switching instruction apparatuses of the first to sixth embodiments are different from the switching instruction apparatus of the seventh embodiment in a path switching method. Specifically, the above-described switching instruction apparatuses of the first to sixth embodiments have been configured to perform the path switching in units of the lower apparatuses 3 on the basis of the predicted traffic amount, but the switching instruction apparatus of the seventh embodiment is configured to perform path switching for each flow on the basis of a predicted traffic amount.

### [Configurations of Switching Threshold Determination Unit and Switching Determination Unit]

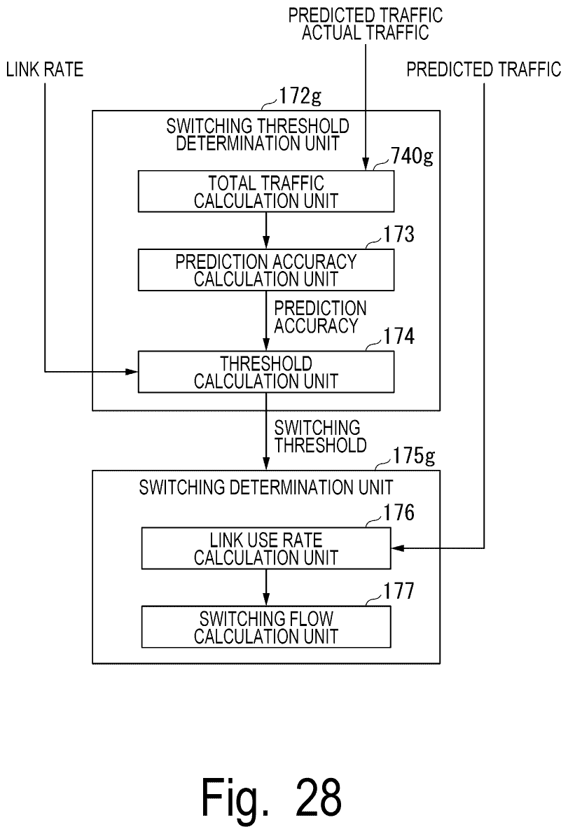

Hereinafter, configurations of the switching threshold determination unit 172g and the switching determination unit 175g of the switching instruction apparatus 17g in the seventh embodiment will be described. FIG. 28 is a block diagram illustrating functional configurations of the switching threshold determination unit 172g and the switching determination unit 175g of the switching instruction apparatus 17g in the seventh embodiment of the present invention.

As illustrated in FIG. 28, the switching threshold determination unit 172g includes a total traffic calculation unit 740g, a prediction accuracy calculation unit 173, and a threshold calculation unit 174.

The total traffic calculation unit 740g acquires the values of the future traffic amounts predicted by the large calculation amount prediction unit 732g, the small calculation amount prediction unit 733, and the traffic estimation unit 734g of the prediction execution unit 730g. The total traffic calculation unit 740g calculates a total traffic amount (hereinafter referred to as a “total actual traffic amount”) of the actual traffic in units of lower apparatuses 3 and a total traffic amount (hereinafter also referred to as a “total predicted traffic amount”) in units of the lower apparatuses 3. The total traffic calculation unit 740g outputs a calculated value of the total actual traffic amount and a calculated value of the total predicted traffic amount to the prediction accuracy calculation unit 173.

The prediction accuracy calculation unit 173 acquires the value of the total actual traffic amount and the value of the total predicted traffic amount output from the total traffic calculation unit 740g. The prediction accuracy calculation unit 173 calculates prediction accuracy for each upper link on the basis of the future traffic amount predicted in the past by the prediction unit 171 and the total actual traffic amount. The prediction accuracy calculation unit 173 outputs information indicating the calculated prediction accuracy to the threshold calculation unit 174.

The threshold calculation unit 174 acquires the information indicating the prediction accuracy output from the prediction accuracy calculation unit 173. The threshold calculation unit 174 calculates the switching threshold for each upper link on the basis of the link rate and the prediction accuracy. The threshold calculation unit 174 outputs the switching threshold of each upper link to the switching determination unit 175g.

As illustrated in FIG. 28, the switching determination unit 175g includes a link use rate calculation unit 176 and a switching flow calculation unit 177.

The link use rate calculation unit 176 acquires the switching threshold of each upper link output from the threshold calculation unit 174. Further, the link use rate calculation unit 176 acquires the value of the total predicted traffic amount from the total traffic calculation unit 740g. The link use rate calculation unit 176 calculates a predicted link use rate for each upper link on the basis of the value of the total predicted traffic amount and the switching threshold. The link use rate calculation unit 176 outputs a calculated value of the link use rate to the switching flow calculation unit 177.

The switching flow calculation unit 177 acquires the value of the link use rate output from the link use rate calculation unit 176. The switching flow calculation unit 177 determines to perform the path switching in a case where there is an upper link that has been determined to have congestion due to a high predicted link use rate, and specifies the path switching that will have a traffic amount in which no congestion occurs in order from a flow with low priority. When determining to perform the path switching, the switching flow calculation unit 177 instructs each apparatus (for example, each of the lower apparatus 3, an upper apparatus 4, and a transfer apparatus 15) to perform the specified path switching.

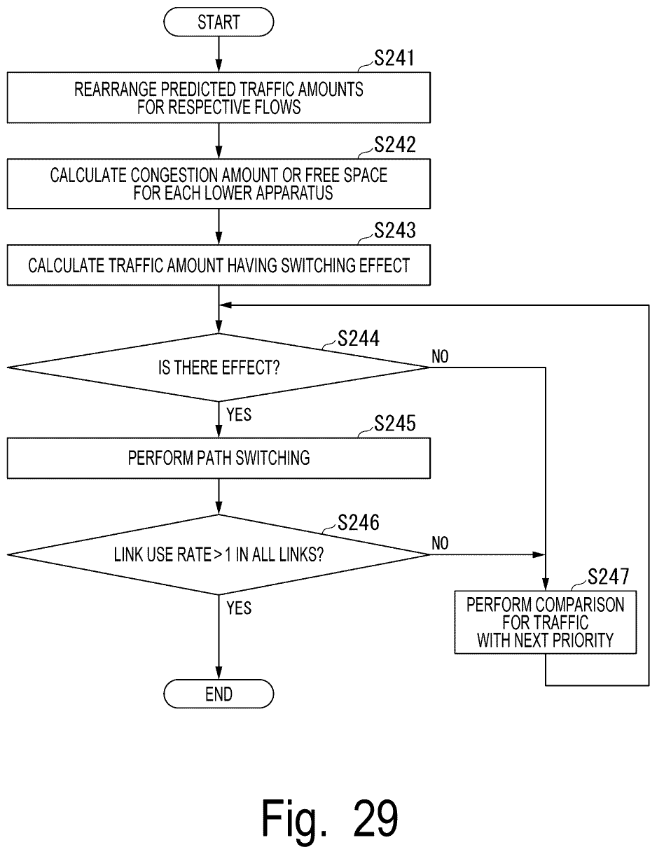

Hereinafter, an example of an operation of the switching flow calculation unit 177 will be described in more detail with a specific example. FIG. 29 is a flowchart illustrating an operation of the switching flow calculation unit 177 of the switching determination unit 175g in the seventh embodiment of the present invention.

The switching flow calculation unit 177 acquires the future traffic amounts and rearranges the predicted traffic amounts for the respective flows. The switching flow calculation unit 177 rearranges the flows in ascending order of priority (step S241). In addition, the switching flow calculation unit 177 calculates a congestion amount (alternatively, a free space in a case of a negative value) for each lower apparatus 3 on the basis of the link use rate of each lower apparatus 3 and the switching threshold as in the following expression (21) (step S242).

$$X\_conv = ( link use rate - 1 ) \times switching threshold \qquad ( 21 )$$

Hereinafter, X_conv that is a positive value of the congestion amount is represented as “X_conv1”, and X_conv that is a negative value of the congestion amount is represented as “X_conv2”.

The switching flow calculation unit 177 specifies the lower apparatus 3 having a maximum value of the congestion amount and the lower apparatus 3 having a minimum value of the congestion amount (that is, a maximum value of the free space). The switching flow calculation unit 177 calculates a maximum value of the traffic amount having an effect of the path switching on the basis of the maximum value of the congestion amount and the maximum value of the free space (step S243).

For example, in a case where the congestion amount of the first lower apparatus 3 is the maximum and the congestion amount of the second lower apparatus 3 is the minimum (that is, the free space is maximum), the maximum value of the traffic amount having the effect of the path switching is expressed by the following expression (22).

$$X = X\_conv 1 - X\_conv 2 \qquad ( 22 )$$

The switching flow calculation unit 177 determines whether or not there is an effect of the path switching by performing the path switching in order from a flow with low priority (step S244).

In a case of determining that there is an effect of the path switching (X>Xi) (step S244: Yes), the switching flow calculation unit 177 issues an instruction to perform the path switching. The switching flow calculation unit 177 causes the link use rate calculation unit 176 to recalculate the link use rate (Link).

$$Link = Link - xi / switching threshold \qquad ( 23 )$$

The switching flow calculation unit 177 changes the lower apparatus 3 to which the switched predicted traffic belongs (step S245).

On the other hand, in a case of determining that there is no effect of the path switching (X≤Xi) (step S244: No), the switching flow calculation unit 177 compares the flows with the next priority (step S247). Note that, in the present embodiment, the comparison is performed in order from a flow with lower priority, but the present embodiment is not limited to such a configuration. For example, the comparison may be performed in order from a flow with a larger traffic amount.

Note that, in a case of performing the path switching for each flow, the switching flow calculation unit 177 notifies the transfer apparatus 15 (switching apparatus) of a differentiated services code point (DSCP) of a flow for which the path switching is to be performed since there is a correspondence between the DSCP and the 5QI.

When the execution determination of the path switching is completed, the switching flow calculation unit 177 again determines whether or not congestion has occurred on the basis of a new link use rate. In a case where the values of all the link use rates are not 1 (that is, the link use rates>1), the switching flow calculation unit 177 terminates the processing.

Thus, the operation of the switching flow calculation unit 177 illustrated in the flowchart of FIG. 29 ends.

As described above, the switching instruction apparatus 17g in the seventh embodiment of the present invention classifies each of the flows input from, for example, the lower apparatus 3 in a predetermined period on the basis of a characteristic of a traffic pattern (for example, Qos) based on information defined in, for example, the 5QI or S-NSSAI. The switching instruction apparatus 17g calculates the burst of the traffic amount (burstiness) on the basis of the time-series variation (difference value) of the traffic amount for each classified flow. The switching instruction apparatus 17g determines, for each flow, whether or not the future traffic amount is predictable using the small calculation amount prediction that is a prediction method with a relatively small calculation amount such as linear prediction or the like on the basis of the calculated burst of the traffic amount (burstiness).

The switching instruction apparatus 17g performs the small calculation amount prediction for the flow determined that the future traffic amount is predictable using the small calculation amount prediction. Meanwhile, the switching instruction apparatus 17g determines whether or not the future traffic amount can be estimated using the traffic estimation for the flow determined that the future traffic amount is not predictable using the small calculation amount prediction.

At this time, the second prediction method determination unit 736 in the present embodiment calculates the number of terminals that has varied for each traffic cycle acquired from the traffic cycle calculation unit 735. The second prediction method determination unit 736 can perform the traffic estimation using the traffic cycle and thus can reduce the number of input data, and thus can further reduce the calculation amount in prediction processing for the future traffic amount.

The switching instruction apparatus 17g performs the traffic estimation for the flow determined that the future traffic amount can be estimated using the traffic estimation. On the other hand, the switching instruction apparatus 17g performs the large calculation amount prediction, which is a prediction method with a relatively large calculation amount, such as a prediction method using machine learning, for the flow determined that the future traffic amount cannot be estimated using the traffic estimation. The switching instruction apparatus 17g adds up the future traffic amounts calculated for the respective flows by the large calculation amount prediction, the small calculation amount prediction, or the traffic estimation, and performs execution determination and execution control of the path switching on the basis of the total traffic amount.

As described above, the switching instruction apparatus 17g in the seventh embodiment of the present invention has the configuration to perform the prediction for each classified flow instead of collectively predicting all the flows in the prediction of the future traffic amount, thereby preventing deterioration in communication quality. Further, the switching instruction apparatus 17g in the seventh embodiment of the present invention is configured to perform the small calculation amount prediction such as linear prediction that can perform prediction with a smaller calculation amount without performing the large calculation amount prediction using, for example, machine learning or the like, for the flow determined that the future traffic amount is predictable using the small calculation amount prediction. Moreover, the switching instruction apparatus 17g in the seventh embodiment of the present invention is configured to perform the traffic estimation that can perform estimation with a smaller calculation amount without performing the large calculation amount prediction using, for example, machine learning or the like, for the flow determined that the future traffic amount can be estimated using the traffic estimation. With such a configuration, the switching instruction apparatus 17g can reduce the calculation amount in the prediction processing for the future traffic amount.

As a result, the switching instruction apparatus 17g can reduce the calculation amount related to the prediction of the future traffic amount and thus can reduce the communication delay caused by incompletion of the prediction of the future traffic amount and the path switching before occurrence of congestion. As described above, the switching instruction apparatus 17g in the seventh embodiment of the present invention can reduce the communication delay while satisfying the communication quality even in a case where a plurality of flows is mixed.

Hereinafter, a determination method in a case where the prediction method determination unit and the first prediction method determination unit in each of the above-described embodiments determine whether or not the future traffic amount is predictable using the small calculation amount prediction will be described. Further, hereinafter, a determination method in a case where the prediction method determination unit and the second prediction method determination unit in each of the above-described embodiments determine whether or not the future traffic amount can be estimated using the traffic estimation will be described.

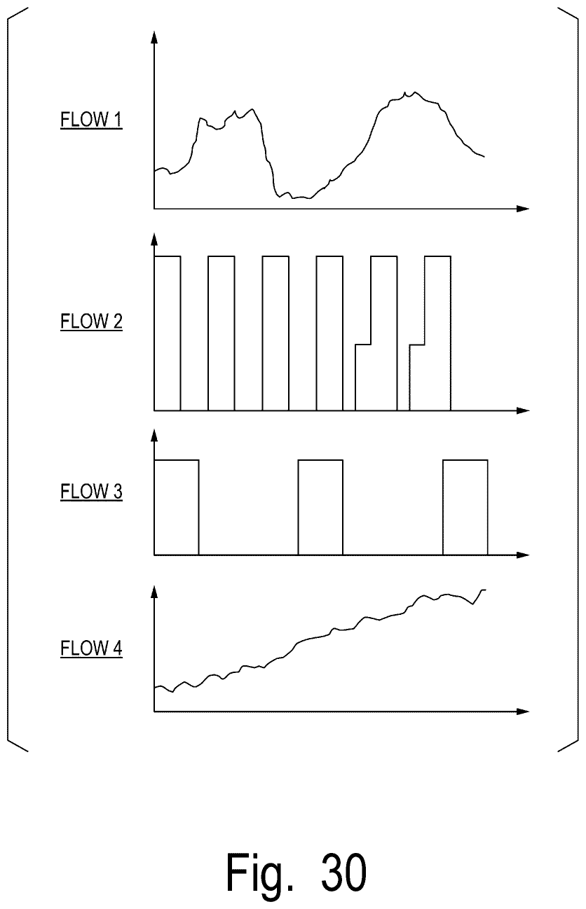

FIG. 30 is a diagram for describing prediction method determination by the prediction method determination unit in each embodiment of the present invention. FIG. 30 illustrates four graphs from Flow 1 to Flow 4. In each graph, the vertical axis represents the traffic amount and the horizontal axis represents time. That is, FIG. 30 is a diagram illustrating, as examples, transition of the time-series traffic amount of four types of flows. Note that, here, it is assumed that the traffic amount is proportional to the number of terminals that are traffic transmission sources.

As illustrated in FIG. 30, Flow 1 and Flow 4 have characteristics that the traffic amount irregularly changes with time. Further, Flow 2 and Flow 3 have characteristics that the presence or absence of occurrence of traffic is alternately repeated at constant intervals (that is, there is burstiness). Moreover, Flow 2 has a characteristic that the traffic amount is not constant at the time of occurrence of the traffic (that is, the number of terminals changes), whereas Flow 3 has a characteristic that the traffic amount is constant at the time of occurrence of the traffic (that is, the number of terminals does not change).

For example, in a case where there are such four types of flows, the prediction method determination unit of each embodiment of the present invention determines the prediction method on the basis of the following rules.

For example, as in the conventional communication system, in a case where the future traffic amount for each flow is predicted by the large calculation amount prediction, there is a problem that a calculation load related to the prediction increases in proportion to the number of flows, the calculation time required for the prediction becomes long, and the path switching cannot be completed before the congestion actually occurs. Therefore, the prediction method determination unit of each embodiment of the present invention performs the above-described small calculation amount prediction or the above-described traffic estimation instead of the large calculation amount prediction according to the traffic characteristics such as the traffic amount and the traffic pattern of each flow, thereby reducing the calculation amount in the prediction processing for the future traffic amount.

For example, the prediction method determination unit determines to perform the small calculation amount prediction instead of the large calculation amount prediction because the small calculation amount prediction such as linear prediction can be used for the flow having the characteristics that the traffic amount continuously changes in time series as in Flow 1 and Flow 4. Note that the accuracy is not secured even if the large calculation amount prediction using machine learning or the like is performed in the flow in which the traffic amount changes as in Flow 1 and Flow 4.

Furthermore, for example, the prediction method determination unit determines not to perform that the small calculation amount prediction because the small calculation amount prediction such as linear prediction cannot be used for the flow having the characteristics that the traffic amount discretely changes with time as in Flow 2 and Flow 3 (that is, for the flows having burstiness). In this case, the prediction method determination unit checks the presence or absence of a change in the number of terminals for each traffic cycle (that is, the traffic amount for each traffic cycle) of the terminal serving as the transmission source of the traffic.

For example, the prediction method determination unit determines to perform the traffic estimation instead of the large calculation amount prediction because the traffic amount can be estimated (that is, the past traffic amount can be regarded as the future traffic amount) for the flow having the characteristic that the number of terminals does not change for each traffic cycle as in Flow 3.

Meanwhile, for example, the prediction method determination unit determines to perform the large calculation amount prediction using machine learning or the like because the past traffic amount cannot be regarded as the future traffic amount for the flow having the characteristic that the number of terminals changes in each traffic cycle as in Flow 2.

In this way, the prediction method determination unit in each of the above-described embodiments can reduce the number of flows for performing the large calculation amount prediction, and reduce the calculation amount in the prediction processing for the future traffic amount.

Note that the above-described first to third embodiments are described assuming a case of using traffic captured from the lower apparatus 3. Note that, in each of the above-described embodiments, the network 5 may be any network such as mobile fronthaul (MFH), mobile midhaul (MMH), or mobile backhaul (MBH).

Note that, in each of the above-described embodiments, the switching instruction apparatus may be configured to acquire traffic information from a controller (not illustrated) of the lower apparatus 3 instead of acquiring the traffic information from the lower apparatus 3.

Note that, in each of the above-described embodiments, the switching instruction apparatus may be configured to use the scheduling information (for example, a buffer status report (BSR), a transport block size (TBS), or the like) in a wireless section instead of using the value of the traffic amount when performing the execution determination of the path switching. In this case, the network 5 is, for example, an MMH or an MBH. In addition, a place from which the scheduling information is acquired is, for example, a DU, a DU controller, a CU, or a CU controller.

Note that, in each of the above-described embodiments, the case of upstream communication has been described as an example, but the present invention is not limited thereto, and a similar configuration can be applied to a case of downstream communication.

Note that, in each of the above-described embodiments, the configuration assuming a 5G mobile network has been described, but the present invention is not limited thereto, and for example, a similar configuration can be applied even in a case of another wireless network such as Wi-Fi (registered trademark). In this case, a place from which the traffic information is acquired is, for example, an access point of Wi-Fi (registered trademark). Furthermore, the network 5 is, for example, a network between a Wi-Fi (registered trademark) controller and an access point of Wi-Fi (registered trademark).

As described above, the above-described switching instruction apparatus in each of the embodiments of the present invention determines whether or not it is possible to perform the small calculation amount prediction or the traffic estimation with a relatively smaller calculation amount than the large calculation amount prediction such as a prediction method using machine learning for each classified flow. Then, the switching instruction apparatus is configured to perform the small calculation amount prediction or the traffic estimation without performing the large calculation amount prediction for the flow determined that the small calculation amount prediction or the traffic estimation can be performed. As a result, the switching instruction apparatus can reduce the calculation amount in the prediction processing for the future traffic amount and thus can reduce the communication delay caused by incompletion of the prediction of the future traffic amount and the path switching before occurrence of congestion. Thereby, the above-described switching instruction apparatus in each embodiment of the present invention can reduce the communication delay while satisfying the communication quality even in a case where a plurality of flows is mixed.

According to the above-described embodiments, a prediction apparatus includes a flow classification unit, a first prediction unit, a second prediction unit, a prediction method determination unit, and a total traffic calculation unit. For example, the prediction apparatus is 171a to 171g in the embodiments, the first prediction unit is the large calculation amount prediction units 732, and 732e to 732g in the embodiments, the second prediction unit is the small calculation amount prediction unit 733 or the traffic estimation units 734, 734d, 734f, and 734g in the embodiments, the prediction method determination unit is the prediction method determination units 731, and 731b to 731e in the embodiments, and the total traffic calculation unit is the total traffic calculation units 740 and 740g in the embodiments.

The flow classification unit classifies communication traffic input during a predetermined period into a plurality of flows on the basis of characteristics of the communication traffic. The above-described first prediction unit predicts the future traffic amount of the flow using a first prediction method on the basis of the current traffic amount of the flow. For example, the first prediction method is the large calculation amount prediction in the embodiments. The above-described second prediction unit predicts the future traffic amount of the flow using the second prediction method having a smaller calculation amount than the first prediction method on the basis of the current traffic amount of the flow. For example, the second prediction method is the small calculation amount prediction or the traffic estimation in the embodiments. The above-described prediction method determination unit determines the prediction method to be used for each flow on the basis of the characteristics of the communication traffic. The above-described total traffic calculation unit calculates the total value of the traffic amount for each flow predicted by the first prediction unit and the traffic amount for each flow predicted by the second prediction unit.

Note that, in the above-described prediction apparatus, the prediction method determination unit may determine to use the second prediction method in a case where a difference value between the traffic amount of the flow in the latest period and the traffic amount of the flow in the previous period is smaller than a predetermined threshold. In this case, for example, the prediction apparatus is the prediction unit 171 in the first embodiment, the prediction method determination unit is the prediction method determination unit 731 in the first embodiment, the difference value is the value of Traffic burst in the first embodiment, and the predetermined threshold is the value of T_th in the first embodiment.

Note that, in the above-described prediction apparatus, the prediction method determination unit may determine to use the second prediction method in a case where an average value of the traffic amount of the flow in the latest period is smaller than a predetermined threshold. In this case, for example, the prediction apparatus is the prediction unit 171b in the second embodiment, the prediction method determination unit is the prediction method determination unit 731b in the second embodiment, the average value is the value of Traffic_ave in the second embodiment, and the predetermined threshold is the value of T_th in the second embodiment.

Note that, in the above-described prediction apparatus, the prediction method determination unit may determine not to use the first prediction method in a case where there is no variation in the number of terminals that are transmission sources of the communication traffic. In this case, the prediction apparatus is the prediction unit 171c in the third embodiment and the prediction unit 171d in the fourth embodiment, the prediction method determination unit is the prediction method determination unit 731c in the third embodiment and the prediction method determination unit 731d in the fourth embodiment, and the number of terminals is the value of Num_val in the third embodiment and the fourth embodiment.

Note that, in the above-described prediction apparatus, the prediction method determination unit may determine not to use the first prediction method in a case where there is no variation in the number of terminals in the latest period. In this case, the prediction apparatus is the prediction unit 171d in the fourth embodiment, the prediction method determination unit is the prediction method determination unit 731d in the fourth embodiment, and the number of terminals is the value of Num_val in the fourth embodiment.

Note that the above-described prediction apparatus may further include a traffic cycle calculation unit. In this case, for example, the prediction apparatus is the prediction unit 171d in the fourth embodiment, the prediction unit 171e in the fifth embodiment, the prediction unit 171f in the sixth embodiment, and the prediction unit 171g in the seventh embodiment, and the traffic cycle calculation unit is the traffic cycle calculation units 735 in the fourth and fifth embodiments, the traffic cycle calculation unit 735f in the sixth embodiment, and the traffic cycle calculation unit 735g in the seventh embodiment. In this case, the traffic cycle calculation unit calculates the cycle of the communication traffic on the basis of the traffic amount. Further, in this case, the first prediction unit predicts the future traffic amount for each cycle calculated by the traffic cycle calculation unit.

In addition, according to the above-described embodiments, a communication control apparatus includes a flow classification unit, a first prediction unit, a second prediction unit, a prediction method determination unit, a total traffic calculation unit, a switching determination unit, and a switching instruction unit. For example, the prediction apparatus is 171a to 171g in the embodiments, the first prediction unit is the large calculation amount prediction units 732, and 732e to 732g in the embodiments, the second prediction unit is the small calculation amount prediction unit 733 or the traffic estimation units 734, 734d, 734f, and 734g in the embodiments, the prediction method determination unit is the prediction method determination units 731, 731b to 731e in the embodiments, the total traffic calculation unit is the total traffic calculation units 740 and 740g in the embodiments, the switching determination unit is the switching determination units 175 and 175g in the embodiments, and the switching instruction unit is the switching instruction apparatuses 17a to 17g in the embodiments.

The flow classification unit classifies communication traffic input during a predetermined period into a plurality of flows on the basis of characteristics of the communication traffic. The above-described first prediction unit predicts the future traffic amount of the flow using a first prediction method on the basis of the current traffic amount of the flow. For example, the first prediction method is the large calculation amount prediction in the embodiments. The above-described second prediction unit predicts the future traffic amount of the flow using the second prediction method having a smaller calculation amount than the first prediction method on the basis of the current traffic amount of the flow. For example, the second prediction method is the small calculation amount prediction or the traffic estimation in the embodiments. The above-described prediction method determination unit determines the prediction method to be used for each flow on the basis of the characteristics of the communication traffic. The above-described total traffic calculation unit calculates the total value of the traffic amount for each flow predicted by the first prediction unit and the traffic amount for each flow predicted by the second prediction unit. The above-described switching determination unit predicts the presence or absence of occurrence of congestion in the future on the basis of the total value, and determines the necessity of switching the communication path on the basis of the prediction result. In a case where the switching determination unit determines that switching of the communication path is necessary, the switching instruction unit gives a switching instruction to the switching apparatus that executes the switching of the communication path. For example, the switching apparatus is the transfer apparatus 15 in the embodiment.

A part or all of the configurations of the switching instruction apparatus in the above-described embodiment may be implemented by a computer. In that case, a program for implementing this function may be recorded in a computer-readable recording medium, and the program recorded in the recording medium may be read and executed by a computer system to implement this function. Note that the “computer system” referred to herein includes an OS and hardware such as peripheral equipment. In addition, the “computer-readable recording medium” refers to a portable medium such as a flexible disk, a magneto-optical disk, a ROM, or a CD-ROM, or a storage apparatus such as a hard disk built in a computer system. Moreover, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside the computer system serving as a server or a client in that case. Furthermore, the program described above may be for implementing some of the functions described above, may be implemented in a combination of the functions described above and a program already recorded in the computer system, or may be implemented using a programmable logic apparatus such as a field programmable gate array (FPGA).

Although the embodiments of the present invention have been described in detail with reference to the drawings, specific configurations are not limited to the embodiments, and include design and the like within the scope of the present invention without departing from the concept of the present invention.

### REFERENCE SIGNS LIST

1 Communication system
3 Lower apparatus, and first lower apparatus and second lower apparatus
3-1 to 3-4 Lower apparatus
4, 4-1 to 4-2 Upper apparatus
5 Network
7 Switching instruction apparatus
10 Mobile communication system
11 Terminal station
12, 12-m Antenna station
13, 13-1, 13-m, 3-M Distributed station
14, 14-1, 14-n, 14-N Aggregation station
15 Transfer apparatus
16 Resource allocation apparatus
17, 17a to 17g Switching instruction apparatus
20 Upper network
71 Prediction unit
72 Switching threshold determination unit
73 Prediction accuracy calculation unit
74 Threshold calculation unit
75 Switching determination unit
171, 171a to 171g Prediction unit
172, 172g Switching threshold determination unit
173 Prediction accuracy calculation unit
174 Threshold calculation unit
175, 175g Switching determination unit
176 Link use rate calculation unit
177 Switching flow calculation unit
710 Flow classification unit
720 Flow information storage unit
729 Flow information storage unit
730, 730b to 730g Prediction execution unit
731, 731b to 731e Prediction method determination unit
731f, 731g First prediction method determination unit
732, 732e to 732g Large calculation amount prediction unit
733 Small calculation amount prediction unit
734, 734d, 734f, 734g Traffic estimation unit
735, 735f, 735g Traffic cycle calculation unit
736 Second prediction method determination unit
740, 740g Total traffic calculation unit

1. A prediction apparatus comprising:
a memory; and
a processor connected to the memory, the processor being configured to perform:
classify communication traffic input during a predetermined period into a plurality of flows on a basis of a characteristic of the communication traffic;
predict a future traffic amount of the flow using a first prediction method on a basis of a current traffic amount of the flow;
predict a future traffic amount of the flow using a second prediction method having a smaller calculation amount than the first prediction method on the basis of the current traffic amount of the flow;
determine a prediction method to be used for each of the flows on the basis of the characteristic of the communication traffic; and
calculate a total value of the traffic amount for each of the flows and the traffic amount for each of the flows predicted.

2. The prediction apparatus according to claim 1, wherein the processor is configured to determine to use the second prediction method in a case where a difference value between the traffic amount of the flow in a latest period and the traffic amount of the flow in a previous period is smaller than a predetermined threshold.

3. The prediction apparatus according to claim 1, wherein the processor is configured to determine to use the second prediction method in a case where an average value of the traffic amount of the flow in a latest period is smaller than a predetermined threshold.

4. The prediction apparatus according to claim 1, wherein the processor is configured to determine not to use the first prediction method in a case where there is no variation in a number of terminals that are transmission sources of the communication traffic.

5. The prediction apparatus according to claim 4, wherein the processor is configured to determine not to use the first prediction method in a case where there is no variation in the number of terminals in a latest period.

6. The prediction apparatus according to claim 1, wherein the processor is configured to:
calculate a cycle of the communication traffic on a basis of the traffic amount, and
the future traffic amount for each cycle calculated.

7. A communication control apparatus comprising:
a memory; and
a processor connected to the memory, the processor being configured to perform:
classify communication traffic input during a predetermined period into a plurality of flows on a basis of a characteristic of the communication traffic;
predict a future traffic amount of the flow using a first prediction method on a basis of a current traffic amount of the flow;
predict a future traffic amount of the flow using a second prediction method having a smaller calculation amount than the first prediction method on the basis of the current traffic amount of the flow;
determine a prediction method to be used for each of the flows on the basis of the characteristic of the communication traffic;
calculate a total value of the traffic amount for each of the flows predicted by the first prediction unit and the traffic amount for each of the flows predicted by the second prediction unit;
predict presence or absence of occurrence of congestion in a future on a basis of the total value, and determine necessity of switching of a communication path on a basis of a prediction result; and
issue a switching instruction to a switching apparatus that executes the switching of a communication path in a case where the it is determined that the switching of a communication path is necessary.

8. A prediction method executed by a computer, the prediction method comprising:
classifying communication traffic input during a predetermined period into a plurality of flows on a basis of a characteristic of the communication traffic;
predicting a future traffic amount of the flow using a first prediction method on a basis of a current traffic amount of the flow;
predicting a future traffic amount of the flow using a second prediction method having a smaller calculation amount than the first prediction method on the basis of the current traffic amount of the flow;
determining a prediction method to be used for each of the flows on the basis of the characteristic of the communication traffic; and
calculating a total value of the traffic amount for each of the flows predicted and the traffic amount for each of the flows predicted.

9. The prediction apparatus according to claim 2, wherein the processor is configured to:
calculate a cycle of the communication traffic on a basis of the traffic amount, and
predict the future traffic amount for each cycle calculated.

10. The prediction apparatus according to claim 3, wherein the processor is configured to:
calculate a cycle of the communication traffic on a basis of the traffic amount, and
predict the future traffic amount for each cycle calculated.

11. The prediction apparatus according to claim 4, wherein the processor is configured to:
calculate a cycle of the communication traffic on a basis of the traffic amount, and
predict the future traffic amount for each cycle calculated.

12. The prediction apparatus according to claim 5, wherein the processor is configured to:
calculate a cycle of the communication traffic on a basis of the traffic amount, and
predict the future traffic amount for each cycle calculated.
